(19) United States
(12) Patent Application Publication
(10) Pub. No.: US 2015/0209801 A1
(43) Pub. Date: Jul. 30, 2015

(54) MONOTHIOPHOSPHATE CONTAINING COLLECTORS AND METHODS

(71) Applicant: Teebee Holdings Pty Ltd., Mona Vale, New South Wales (AU)

(72) Inventor: Alexander Bradstock Tall, Newport (AU)

(21) Appl. No.: 14/415,526

(22) PCT Filed: Jul. 17, 2013
(86) PCT No.: PCT/AU2013/000790

§ 371 Date: Jan. 16, 2015

(30) Foreign Application Priority Data
Jul. 17, 2012 (AU) 2012903052

(51) Int. Cl. B03D 1/012; B03D 1/014; B03D 1/02

(52) U.S. Cl. CPC B03D 1/012; B03D 1/02; B03D 1/014; B03D 2201/02; B03D 2203/025

(57) ABSTRACT

Novel collectors in the form of mixtures of one or more monothiophosphates and one or more thionocarbamates, optionally containing other materials useful for enhancing the performance of the collectors, are used in froth flotation processes for the recovery of selected metals or minerals, such as gold, silver, copper, zinc or similar contained in the ore material being treated. Not only to the combinations of monothiophosphates and thionocarbamates produce more efficient collectors which improve the yield and selectivity of the recovery of the metal or mineral from the ore being treated, but the use of the monothiophosphate allows new combinations of collectors to be formed that do not separate on standing thus avoiding the disadvantage of having to stir the collector mixtures immediately prior to use. Specific examples of the monothiophosphates are disclosed.

### FIELD OF THE INVENTION

The present invention relates to reagents or combinations of reagents for use as collectors in mining operations.

One form of the present invention relates to collectors which are used to improve the yield of metal values and/or minerals recovered from a wide range of raw materials, including raw materials such as ores, mineral pulps, slags, tailings, waste materials and similar, and to methods of using the reagents in metal and mineral recovery processes.

One form of the present invention relates to collectors which are used to improve the selectivity of metal valves and/or minerals recovered from a wide range of raw materials.

In one aspect, the present invention relates to reagents which are used as collectors for increasing the recovery of selected metals and/or minerals from materials being treated, such as for example raw materials, including particularly ores, mineral pulps and slags, so that greater amounts of the selected metal or metals and/or mineral or minerals are recovered from the material being treated (i.e. the yield is improved) along with lesser amounts of unwanted materials, such as contaminating and/or competing materials (i.e. increased selectivity of a particular metal or mineral), particularly lesser amounts of gangue or other waste materials or other materials competing with the selected metal and/or mineral for recovery from the materials being treated by the collector or collectors.

In one embodiment, the present invention relates generally to improved collectors comprising mixtures of two or more different reagents in which the collectors have enhanced properties in froth flotation operations, including both selective flotation operations and bulk flotation operations, to concentrate metal values from ores or mineral pulps or slags to allow the extraction of greater amounts of selected or desired metal values and/or minerals from the ores, mineral pulps, slags or similar during the flotation processes and to methods of using the improved mixtures to increase the yield of recovered metals and/or minerals and/or to increase the grade of the metal or mineral recovered in the froth flotation process by substantially rejecting gangue and/or waste materials and/or other competing materials, particularly rejecting the recovery of competing materials along with the particular selected metal or mineral.

In one embodiment, the present invention relates to new and improved reagents comprising mixtures and/or reactions of monothiophosphate(s) with other monothiophosphate(s), and/or mixtures and/or reactions of other materials, such as for example thiocarbamates, dithiophosphates, and other materials alone or with other combinations of such materials, mercaptobenzothiazole(s) for use as improved collectors in recovering desired mineral(s) and/or metal values from ores, pulps, slags or similar in greater amounts and/or in greater concentrations, and/or having improved grades of recovered material in the resultant concentrate.

Although the present invention will be described with particular reference to specific mixtures and/or reactions and/or product(s) of the reaction(s) of specific reagents for use as collectors for selected mineral(s) and/or metal(s), it is to be noted that the scope of the present invention is not restricted to the described embodiments only but rather the scope of the present invention is broader so as to encompass other combinations of mixtures and/or reactions and/or product(s) of reaction(s) of reagents useful as collectors either with themselves, with other examples of the same type of collectors or with other types of collectors, the use of the various mixtures of reagents to extract other minerals and/or metals, and the use of the reagents in applications and installations other than the recovery methods described.

### BACKGROUND OF THE INVENTION

Froth flotation is one of the most important and versatile mineral processing techniques in use in mining operations on a worldwide basis to recover metal values generally from suitable materials, including ores and/or mineral pulps. Froth flotation is a widely used method of concentrating ores and is believed to be the most commonly used concentrating process in the mining industry. Not only is froth flotation used to extract greater amounts of metal values generally i.e. yield, but, more importantly, froth flotation is a selective process that can be used to achieve selective separation of a desired metal or small select range of desired metals from complex ores or mineral pulps containing different metal values or a range of different metals, such as for example using bulk flotation processes, particularly competing metals, so that increased amounts of the selected minerals or metals can be recovered from the materials being treated and/or improving the grade of the minerals or metals that are extracted.

Flotation is based on the principle of introducing air or gas bubbles into a finely ground ore pulp or into relatively fine particle mixtures containing minerals as one of the components of the particles so that particles of some of the minerals in the mixture or pulp become attached to the bubbles of air or gas and float to the surface of the mixture thereby bring the metal component to the surface for subsequent removal in the froth accumulating at the surface, whereas other minerals will not become attached to the air or gas bubbles but rather will remain in the pulp or mixture or will sink to the base of the vessel in which the treatment is taking place, thus allowing the selected minerals to be separated from the remaining unwanted materials. The selective attachment of some minerals and not others allows some mineral values to be separated from other minerals and/or gangue by floating the selected minerals or metals to the surface of the vessel in which the flotation occurs thus separating the selected metals or minerals from the residue remaining within or at the base of the vessel. Additionally, the selective extraction of one metal also allows more of the selected metal to be recovered by floating the selected metal particles to the surface along with the air bubbles so as to concentrate the metal particles thereby extracting more of the selected particles. Thus, the use of collectors increases the amount of metal or mineral recovered, i.e. increases the yield, and also the grade of the recovered metal or mineral is increased, i.e. increase in selectivity. Sometimes groups of similar metals are extracted in combination using bulk flotation techniques.

Most minerals are not water repellent in their natural state so that flotation agents or reagents must be added to the pulp in order to increase the water repellancy of the minerals which in turn increases their affinity for being entrained or adsorbed onto and/or within the air or gas bubbles. One of the most important class of reagents used in the froth flotation processes are collectors, sometimes referred to as promoters, which are adsorbed onto the mineral surfaces thereby rendering the surfaces hydrophobic (or aerophilic) which facilitates attachment of the bubbles of gas or air to the mineral particles. A number of different theories have been put forwarded to explain the increase in hydrophobicity of the mineral particles, such as for example, by cleaning the surface of the metal or mineral particles, by altering the polarity of the surface of the metal or mineral particle, by redistributing the charge on the surface of the mineral particle and the like. It is unimportant to the scope of the present invention how the increase in hydrophobicity is achieved, only that the addition of collectors or promoters improves the yield and/or selectivity of metals being recovered. Thus, the addition of collectors increases the hydrophobicity of the minerals allowing them to be floated more easily.

Collectors can be defined as being organic compounds which render selected minerals water repellent by adsorption of molecules or ions onto the mineral surface, reducing the stability of the hydrated layer separating the mineral surface from the air or gas bubble to such a level that attachment of the particle to the bubble can be made on contact. It is the attachment of the air or gas bubble to the mineral or metal containing particle that allows the particle to rise to the surface. Different collectors are used for different minerals and/or metals and for separating selected metals from other similar metals. Also different amounts of collectors are used to recover different metals in different environments and in different circumstances. Collectors are of great importance in the recovery of metal values from ores or mineral pulp because very small improvements in the efficiency of the collector being used in a particular situation can have significant economic advantages for operating the recovery system for a selected metal. If the addition of the collector results in even a very small increase in the amount of metal value being selectively recovered, this could make the difference between a particular process being commercially viable or not and/or the treatment of a particular ore body being economically viable.

Also, with an increasing emphasis on retreating or reworking old workings, such as previously treated tailings, both from a cost recovery point of view and an environmental impact point of view, the role being played by the collectors is assuming increasing importance, and accordingly there is a demand for more efficient collector systems that are more economical to use by being less expensive to produce and/or requiring lower dosages to extract the selected metal or mineral and which have little or no adverse environmental effects. Thus, there is a need for improved collectors and their methods of use.

Accordingly, it is an aim of the present invention to provide a collector or collector system or collector mixtures and/or reactions and/or product(s) of reaction(s) of reagents for use in froth flotation processes which results in improved recovery of selected mineral and/or metal values from the ore or mineral pulp, slags, tailings, waste materials, or the like being treated in the froth flotation process.

Another aim of the present invention is to provide a collector or collector system or collector mixtures and/or reactions and/or product(s) of reaction(s) which are useful in recovering copper, zinc, lead, nickel, platinum, palladium, other platinum group minerals and metals, gold and silver from ores, pulps, smelting slags and similar raw materials containing these substances, respectively so as to enhance the commercial viability of the recovery of such substances from the raw materials containing these substances.

Another aim of the present invention is to provide a method of treating raw materials such as ores, pulps, slags and similar with the collectors of the present invention in flotation processes to improve the recovery of mineral and/or metal values from the raw material.

It has now been discovered that superior collectors can be formed from mixtures and/or reactions of two or more reagents, optionally with other chemical additives included in the reagent mixtures and/or reactions, and that such combinations of collectors can be used to treat different raw materials to recover metals of interest.

One problem associated with existing collectors is that some of the existing collector systems require the separate addition of two or more individual collectors either at different locations within the overall installation or at different times in the operation of the installation since the collector cannot be added as a mixture because the mixture is unstable due to the individual reagents having a tendency to separate from each other within the mixtures over time or on standing or within a short period of time after stirring has stopped.

As an example, some existing collector mixtures separate into two liquid phases on standing when left unstirred. This is an undesirable situation since separation of the mixture into the individual components reduces the efficacy of the mixture if used in a separated or partially separated state or, alternatively, the mixture requires continual stirring during storage or immediately prior to use to prevent separation, both of which either reduce the yield of the mineral and/or metal recovered or the grade of the metal recovered in the flotation process or add to the cost of recovering the metal values by requiring one or more additional processing step and/or additional equipment to be provided in the overall treatment plant or similar.

Therefore, if it were possible to discover one or more mixtures of reagents that were useful as collectors, particularly in recovering zinc and/or copper and/or gold, and/or silver, and/or nickel, and/or a platinum group metal, and/or lead and/or a palladium group minerals and/or metals, or for that matter, any metal or mineral of economic worth, which mixtures of reagents were stable on storage and did not require continual stirring on storage, then further increases of efficiency and efficacy could be gained resulting in more economically viable recovery of metal values and minerals from the raw materials being treated. Thus, another aim of the present invention is to be able to produce a collector or collector system or collector mixtures and/or reactions and/or products of reactions that have at least a reduced tendency to separate from one another or into separate phases or do not substantially separate from one another when left unstirred. It is to be noted that not all embodiments of the present invention satisfy all of the aims of the present invention. Some embodiments will satisfy one aim whilst other embodiments will satisfy another aim. Some embodiments may satisfy two or more aims.

### SUMMARY OF THE INVENTION

According to one aspect of the present invention, there is provided a collector or collector system or collector mixture for use in recovering, and/or concentrating a metal or mineral value of economic worth from a raw material containing the metal and/or mineral of economic worth in a froth flotation process, characterised in that the collector comprises at least one or more reagents selected from the following groups of reagents either in combination with a member from the same group of reagents, or in combination with one or more reagents selected from at least one other group or other groups of reagents, wherein one group of reagents is

A) one or more reagent(s) of a thionocarbamate having the general formula (I)

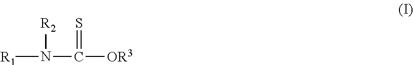

in which R₁, R₂and R³ are the same or different and are selected from hydrogen, alkyl groups, allyl groups, alkenyl groups, aryl groups or alkaryl groups having from 1 to 20 carbon atoms including linear or branched carbon chains and substituted or un-substituted carbon atoms including being substituted with a hetero atom,

and another group of reagents is

(B) one or more reagents of a monothiophosphate having the general formula

(R₄O)₂PS(OR₅) (II)
in which R₄ and R₅ are the same or different and is selected from hydrogen, oxygen, alkyl groups, allyl groups, alkenyl groups, aryl groups or alkaryl groups having from 1 to 20 carbon atoms, including branched or un-branched carbon chains and unsubstituted or substituted carbon atoms including hetero atoms.

Typically, the collector compositions of the present invention can optionally include another group of reagents. More typically, the other group is (C) in which one example of (C) is one or more reagents of a dithiophosphate having the general formula (III)

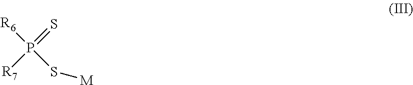

in which R₆ and R₇ are the same or different and is selected from hydrogen, alkyl groups, alkenyl groups, aryl groups or alkaryl groups having from 1 to 20 carbon atoms, including branched or un-branched carbon chains and un-substituted or substituted carbon atoms including hetero atoms, and M is an alkali metal selected from Group I of the Periodic Table or is an ammonium ion, including substituted ammonium ions or a cresyl, a substituted cresyl or a cresyl-containing group.

Another example of reagent (C) is
one or more of mercaptobenzothiazole of the general formula (IV)

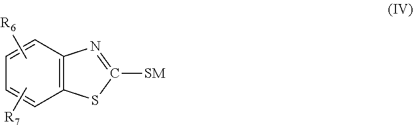

in which R₆ and R₇ may be the same or different and are selected from hydrogen, alkyl groups, alkenyl groups, aryl groups or alkaryl groups having from 1 to 20 carbon atoms including branched or unbranched carbon chains and substituted or unsubstituted carbon atoms including hetero atoms and M is hydrogen, an alkali metal selected from Group I of the periodic table, an ammonium ion, a substituted ammonium ion, a cresyl, a substituted cresyl or cresyl-containing group.

Other examples of (C)are possible.

According to another aspect of the present invention there is provided a method of recovering at least one selected metal and/or mineral from a raw material in a froth flotation process using a collector, collector system, collector mixture, comprising the steps of
introducing the collector to the raw material and subjecting the raw material to a froth floatation process wherein the collector or collector system or collector mixture product(s) of reactions of collectors are capable of being used for concentrating metal values and/or minerals from ores, mineral pulps, and/or slags or other raw materials containing metal and/or mineral in froth flotation processes, said collector, collector system or collector mixture and/or reaction comprising at least one or more reagents selected from the following groups of reagents either in combination with a member from the same group of reagents, or in combination with one or more reagents selected from at least one other group or other groups of reagents in which one group of reagents is

(A) One or more reagent(s) of a thionocarbamate having the general formula (I)

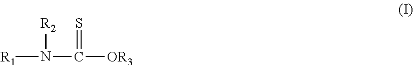

in which R₁, R₂ and R₃ are the same or different and are selected from hydrogen, alkyl groups, allyl groups, alkenyl groups, aryl groups or alkaryl groups having from 1 to 20 carbon atoms including linear or branched carbon chains and substituted or un-substituted carbon atoms including being substituted with a hetero atom, and

another group of reagents is

(B) one or more reagents of a monothiophosphate having the general formula (II)

(R₄O)₂PS (OR₅) (II)
in which R₄ and R₅ are the same or different and is selected from hydrogen, oxygen, alkyl groups, alkenyl groups, aryl groups or alkaryl groups having from 1 to 20 carbon atoms, including branched or un-branched carbon chains and un-substituted or substituted carbon atoms including hetero atoms.

Typically, the collector composition can optimally include one or more of reagent (C) which is selected from a range of different materials. One example of reagent (C) is
one or more reagents of a dithiophosphate having the general formula (III)

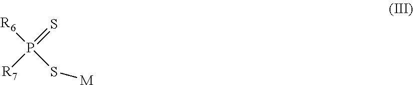

in which R₆ and R₇ are the same or different and is selected from hydrogen, alkyl groups, alkenyl groups, aryl groups or alkaryl groups having from 1 to 20 carbon atoms, including branched or un-branched carbon chains and un-substituted or substituted carbon atoms including hetero atoms, and M is an alkali metal selected from Group I of the Periodic Table or is an ammonium ion, including substituted ammonium ions or a cresyl, a substituted cresyl or a cresyl-containing group.

Another example of reagent (C) is one or more of mercaptobenzothiazole of the general formula (IV)

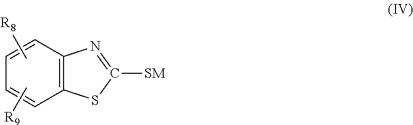

in which R₈ and R₉ may be the same or different and is selected from hydrogen, alkyl groups, allyl groups, alkenyl groups, aryl groups or alkaryl groups having from 1 to 20 carbon atoms including branched or unbranched carbon chains and substituted or unsubstituted carbon atoms including hetero atoms and M is hydrogen, an alkali metal selected from Group I of the periodic table, an ammonium ion, a substituted ammonium ion, a cresyl, a substituted cresyl or cresyl-containing group.

### BRIEF DESCRIPTION OF THE INVENTION

The collectors of the present invention can be used to treat a wide variety of different raw materials, including fresh materials, virgin materials, waste materials, recycled materials, previously treated materials or the like including combinations of two or more such materials. Typical examples of the materials that can be treated by the collectors of the present invention include sulphidic ores, slags, oxidised ores, transition ores, supergene ores, ores containing oxidized sulphides and similar. Particularly preferred ores include sulphidic ores and/or sulphur containing ores.

Typically, the collector of the present invention further comprises one or more additives. The additives, if present, can be one or more other collectors including collectors of the present invention or other types of collectors, such as for example, dithiophosphates, xanthate esters, or the like. The one or more other collectors can be collectors in accordance with the present invention such as reagents selected from reagent groups (A) or (B) and optionally (C) either individually or optionally in combination or in combination with other collectors, such as for example, reagents selected from another group of reagents, group (D), which are collectors that are novel or typically, conventionally or traditionally used in froth flotation separation processes. Examples of other collector reagents, group (D) reagents, are provided later in this specification.

In different forms of the invention, mixtures of reagents and/or reactions of reagents include the following:
(i) mixtures of one or more reagents selected from group (A) with one or more reagents selected from group (B),
(ii) mixtures of one or more reagents selected from group (A) and one or more reagents selected from group (B) with one or more reagents selected from group (C),
(iii) one or more reagents selected from group (A) with one or more reagents selected fro group (B) with one or more reagents selected from group (D),
(iv) mixtures of one or more reagents from group (A) with one or more reagents from group (B) with one or more reagents from group (C) and with one or more reagents from group (D).

In other forms, each of the above described reagent mixtures or reactions can optionally contain other collectors and/or other additives, such as for example, reagents from group (D).

In another form of the invention the mixture and/or reaction of reagent(s) selected from one or more of groups (A)and (B) and optionally (C) and/or (D) form a stable mixture, preferably a stable mixture that does not separate when not being stirred, more preferably a stable mixture that does not separate on standing and most preferably a mixture that does not separate after mixing and does not require stirring to mix the reagents prior to use, particularly shortly before or immediately before use.

It is to be noted that any suitable or convenient thionocarbamate can be used to form the collectors of the present invention, including all thionocarbamates.

Further, it is to be noted that any or all monothiophosphate, typically any suitable or convenient monothiophosphate, can be used in forming the collectors of the present invention.

One form of the monothiophosphate is the mono-ester and the di-ester of sodium diisobutyl monothiophosphate or isobutyl sodium phosphorothioate.

Further, it is to be noted that monothiophosphate can have one, two, or three anion substituents, such as for example one, two or three sodium ions depending upon the actual substituents.

Reagents of the present invention in accordance with either formula I or formula II or formula III or formula IV, are those in which each of the substituents by any one of R₁ to R₉ may be the same or different and are each selected from one or more of methyl, ethyl, n-propyl, iso-propyl, n-butyl, iso-butyl, sec-butyl, tert-butyl, isoamyl, n-pentyl, iso-pentyl, neopentyl, n-hexyl, n-heptyl, n-octyl, m-cresyl, o-cresyl, p-cresyl, benzyl groups (—CH₂-C₆H₅) or combinations or mixtures or isomers of two or more of the foregoing or the like including derivatives of and precursors of the reagents. Functional substituents other than those exemplified are also within the scope of the present invention, such as for example, the anilino group containing the nitrogen atom. It is to be noted that some forms of the collectors have two or more such substituent groups, such as for example, diisobutly, disecbutyl, diisopentyl or the like, without limitation.

Preferred reagents useful for making collectors or mixtures of collectors in accordance with the present invention include the following:
Reagent (A)—Thionocarbamates
Alkyl Alkyl Thionocarbamates
Isobutyl Allyl, Ethyl, Diethyl, Methyl Dimethyl, Propyl, Propenyl, Allyl Thionocarbamates
Isopropyl Allyl, Ethyl Diethyl, Methyl DimethylButyl Dibutyl, Propyl, Propenyl, Allyl Thionocarbamate with isopropyl propyl thionocarbamate being particularly preferred
Amyl Methyl Thionocarbamate
Isoamyl Ethyl thionocarbamate
Ethyl Butyl Thionocarbamate
Ethyl Propyl Thionocarbamate
Methyl isobutyl Carbinol Thionocarbamate (MIBC)
Methyl isobutyl Carbinol Ethyl Thionocarbamate
Octyl Thionocarbamate

Further examples of Reagent (A) include the following:
Isopropylmethylthionocarbamate
Isobutylmethylthionocarbamate
Isopropylethylthionocarbamate
Isobutylethylthionocarbamate
Isopropylpropylthionocarbamate.

### Reagent (B)—Monothiophosphates

Any suitable form of the monothiophosphate including any suitable monothiophosphate salts can be used. Typical examples of the salts include the following:

The Sodium, Potassium, Ammonium, and Zinc salts at least, of all monothiophosphates, including salts of the following:
Sodium, Potassium, Ammonium, and Zinc salts of
iso & Diisobutyl Monothiophosphates;
sec & Disecondarybutyl Monothiophosphates;
iso & Diisopropyl Monothiophosphates;
iso & Diisopentyl Monothiophosphates;
cresyl & dicresyl Monothiophosphates;
di-p-cresyl Monothiophosphates

### Reagent (C)

Mercaptobenzothiazole in the acid form
Sodium Mercaptobenzothiazole
Potassium Mercaptobenzothiazole

Dithiophosphates, including the following:
Sodium di-isobutyl dithiophosphate
Potassium di-isobutyl dithiophosphate
Ammonium di-isobutyl dithiophosphate
Sodium diethyl dithiophosphate
Potassium diethyl dithiophosphate
Ammonium diethyl dithiophosphate
Sodium di-isopropyl dithiophosphate
Potassium di-isopropyl dithiophosphate
Ammonium di-isopropyl dithiophosphate
Sodium di-secbutyl dithiophosphate
Potassium di-secbutyl dithiophosphate
Ammonium di-secbutyl dithiophosphate
Ammonium dicresyl dithiophosphate
Cresyl dicresyl dithiophosphate
Sodium dialkyl dithiophosphate
Potassium dialkyl dithiophosphate
Ammonium dialkyl dithiophosphate

Preferably R of the mercaptobenzothiazole can be at any one or more of the free aromatic positions.

It is to be noted that the mercaptobenzothiazoles useful in the present invention include the acid form as well as all water soluble or water miscible forms of the mercaptobenzothiazoles so that such material can be used in aqueous solutions.

Particularly preferred examples of reagent (A) are Alkyl Alkyl Thionocarbamates, Isobutyl Allyl, Ethyl Diethyl, Methyl Dimethyl, Propyl, Propenyl, Allyl Thionocarbamate, Isopropyl Allyl, Ehtyl Diethyl, Methyl Dimethyl, Butyl Dibutyl, Propyl, Propenyl, Allyl Thionocarbamate, Amyl Methyl Thionocarbamate, Isoamyl Ethyl thionocarbamate, Ethyl Butyl Thionocarbamate, Ethyl Propyl Thionocarbamate, MIBC (Methyl isobutyl Carbinol) Thionocarbamate and MIBC Ethyl Thionocarbamate, Octyl Thionocarbamate including combinations of two or more of the foregoing. It is to be noted that isopropyl propyl thionocarbamate is particularly preferred.

Particularly preferred examples of Reagent (C) are the acid form of mercaptobenzothiazole, such as for example 2-mercaptobenzothiazole, or Sodium Mercaptobenzothiazole, or combinations of both.

Particularly preferred collector mixtures or collector systems contain
(i) at least one or more of isopropyl methyl thionocarbamate and/or isopropyl ethyl thionocarbamate, and/or isobutyl ethyl thionobarbamate, and/or isopropyl propyl thionocarbamate, as well as other thionocarbamates,
(ii) all monothiophosphates, such as for example sodium diethyl monothiophosphate, sodium di-sec-butyl monothiophosphate, sodium diisobutyl monothiophosphate, and sodium diisoamyl monothiophosphate.

Additionally, esters of the above salts can be used in the present invention.

Examples of the alkali metal are Sodium, Potassium, Ammonium, Calcium, Zinc and other Group IIA or IIB metals.

Examples of the substituted ammonium ion are tetramethyl ammonium ion.

Particularly preferred forms of the collectors, such as for example, collectors used as reagent (D) include the following:
diiso propyl propyl thionocarbamate used either alone or in combination with another collector material, preferably selected from other thionocarbamates, dithiophosphates, monothiophosphates, a mercaptobenzothiazole, octyl sulphide, xanthate esters, dithiocarbamates or the like, in any or all combination of two or more such materials.

Particularly preferred forms of (B) the monothiophosphate component of the present invention include the following:
Potassium disecondary butyl monothiophosphate
Potassium diisobutyl monothiophosphate
Sodium dibutyl monothiophosphate

Particularly preferred forms of the collector in accordance with the present invention include the following.

Potassium disecondary butyl monothiophosphate with a first thionocarbamate.

Potassium disecondary butyl monothiophosphate with a first dithiophosphate and a thionocarbamate.

Potassium diisobutyl monothiophosphate with a thionocarbamate.

Potassium disecondary butyl monothiophosphate with a second thionocarbamate, the second dithionocarbamate being a different thionocarbamate to the first thionocarbamate.

Potassium disecondary butyl monothiophosphate with a second dithiophosphate and a further dithionocarbamate.

Sodium diisobutyl monothiophosphate with a thionocarbamate.

Potassium diisobutyl monothiophotphase with another thionocarbamate.

Potassium diisobutyl monothiophosphate with a still further thionocarbamate.

Typically, the collector or collector system can contain any amounts of reagent(s) (A) and/or reagent(s) (B) and/or reagent(s) (C) including from 0-100% reagent(s) (A) and 0-100% reagent(s) (B) on a weight basis in any specific proportion within the weight range specified, and in any combination of amounts, optionally containing an amount of reagent (D) with the proviso that both reagents (A) and (B) be present in the collector.

Typical ranges of reagents (A) and (B) include the following:

From 5 to 95% reagents (A) or (B), from 10-90% reagents (A) or (B) from 20 to 80% reagents (A) or (B), from 30 to 70% reagents (A) or (B), from 40 to 60% reagents (A) or (B), about 50% of reagents (A) or (B) or the like on a weight basis. The amount of reagent (A), (B) or (C) can be the same as one another, or two may be the same as each other, or they may all be different from one another.

All of the above percentages expressed on a weight basis of the total weight of the collector.

In some embodiments, the collector or collector mixtures or collector reactions can include other collectors, such as collectors D. Examples of other collectors are dithiophosphates, xanthates, dithiocarbamates, xanthate esters, including xanthogen formates; dithiocarbamates; dithiophosphates, such as anilino dithiophosphoric acid including salts, esters or the like such as anilino dithiophosphates, dithiophosphinates, octyl sulphides, alcohols, hydroximic acids, salts, esters and similar; and the like including combinations of two or more of the foregoing.

Typically, any other suitable additive can be added to the mixture and/or reaction for any purpose or to enhance the performance of the collectors in any way. Typical examples of other additives include the following:

Surfactants, including anionic and non-ionic surfactants, such as alkylamine ethoxylate containing from 15 to 30 moles of ethylene oxide and nonylphenol ethoxylate with 12 to 20 moles of ethylene oxide, or the like; other additives for other purposes including glycol ethers, dispersants, foamers, processing aids, frothers or other agents promoting frothing of the aerated mixture as well as defoamers or the like. Additionally, the collector mixture can contain water, particularly recycled water from the treatment plant containing impurities, such as the byproducts from the various treatments occurring in the treatment plants, such as for example, xanthates, or the like.

Typically, the amount of additive, such as for example, the amount of surfactant added to the collector mixture and/or reaction is from about 0 to about 20% by weight.

Typically, the pH of the pulp and collector mixture is any value up to about 13, preferably from about 2 to 13, more preferably from about 7 to 11 and most preferably about 8 to 10. However, it is to be noted that the pH of the pulp and collector mixture and/or reaction can be adjusted to any value as required depending upon the content of the pulp, the nature of the metal or mineral being recovered, the type and amount of collectors being used and other parameters including parameters by which the plant in which the flotation step operates.

Typically, the amount of collector mixture and/or reaction added to the raw material is any amount up to about 200 grams per ton of ore being treated, preferably from about 2 g/T to about 150 g/T, more preferably, about 3 g/T to about 100 g/T, even more preferably about 3.5 g/T to about 80 g/T.

The collector mixture and/or reaction can be added to the raw material as a single dose, or in two or more doses, such as in two, three, four or more doses. The doses can be added separately at different time intervals and/or at different spaced apart locations.

The collector can be added at one location within the treatment plant or at two or more different locations within the plant, such as for example, one dose can be added to the grinding mill, to the rougher, to the scavenger or the like whilst other doses can be added to other parts of the plant.

Typically, the metal values being recovered by the present invention particularly include gold, silver, zinc, lead, nickel, platinum group minerals and copper. Other metals or minerals can be recovered either separately or in combination with the gold, silver, zinc, lead, nickel, platinum group minerals, copper or the like.

Typically, the minerals being treated by the collectors of the present invention are sulphide minerals containing gold, silver, copper, lead, nickel, platinum group metals (Platinum, palladium and the like) and zinc containing sulphides and the like. However, other types of minerals can be treated such as oxides, oxidised sulphides or the like.

Embodiments of the present invention will now be described with reference to the following examples.

### EXAMPLE ONE

Extensive flotation testing was performed on copper/gold ore types to assess the relative performance of synthesised flotation collector types.

Flotation collectors were tested under standard conditions that mimicked plant operating conditions for each of the ore types tested.

This example compares selected collector types in accordance with the present invention, with standard operating standards identified as STANDARD as indicated in the table below.

| Ore Source | Collector |
|---|---|
| Ore 1 | Potassium disecondary butyl monothiophosphate + |
| | thionocarbamate |
| | Potassium disecondary butyl monothiophosphate + |
| | dithiophosphate + thionocarbamate |
| | Potassium dibutyl monothiophosphate |
| | Potassium disecondary butyl monothiophosphate |
| | Potassium disecondary butyl monothiophosphate |
| | Sodium-diisobutyl dithiophosphinate (STANDARD) |
| Ore 2 | Sodium-diisobutyl monothiophosphate + thiocarbamate |
| | Sodium-diisobutyl monothiophosphate + thiocarbamate |
| | Sodium diisobutyl dithiophosphate + isopropyl ethyl |
| | thionocarbamate (STANDARD) |
| Ore 3 | Potassium dibutyl monothiophosphate + thiocarbamate |
| | Potassium dibutyl monothiophosphate + thiocarbamate |
| | Isopropyl ethyl (STANDARD) |
| Ore 3 | Potassium dibutyl monothiophosphate + thiocarbamate |
| | Isoproylethyl (STANDARD) |

Each of the synthesised collectors was compared for efficacy against the standard for:
Mass Recovery: proportion of mass reporting to the concentrate product.
Grade of Concentrate: Percentage of copper in concentrate product.
Recovery of copper to concentrate.

For each of the experimental collectors these criteria matched or improved upon the standard results identified as STANDARD and indicate strongly the potential for these experimental collectors to match or exceed the current industrial collector performance.

### 2. SAMPLE RECEIVED

Bulk samples of ore types were received for preparation and testing under four separate project files.

| Ore | Number | Ore |
|---|---|---|
| Ore 1 | A14971 | Copper/Gold ore, fine grained, high sulphide matrix |
| Ore 2 | T0774 | Copper ore, coarse grained, low sulphide, silicate |
| | | matrix |
| Ore 3 | T0784 | Copper/Gold ore, medium grained, low sulphide, |
| | | silicate matrix |
| Ore 3 | T0815 | Copper/Gold ore, medium grained low sulphide, |
| | | silicate matrix |

### 3. TEST METHODS

### Sample Preparation: Ore

Samples were received as crushed lump ore. Samples were crushed in a single toggle lab jaw crusher to 100% passing 25 mm. Crusher discharge was screened at 1.70 mm and screen oversize stage jaw crushed to 100% passing 1.70 mm. The combined crushed ore was rotary split to lots for cold storage.

### GRIND ESTABLISHMENT

Samples of fine ore (100% passing 1.70 mm) were assessed by batch grinding to establish a curve for discharge p80 versus grind time for the grind conditions required for further testing. The following grind conditions were used:
300 mm long×320 mm diameter open ended mill steel mill.
6.0 kg of a graded (10-40 mm diameter) mild ball charge.
1000 gm of prepared ore at 66% solids.
Grind times of 10, 20 and 30 minutes.

Grind discharges were fully removed, filtered, dried and prepared for sizing to 38 um.

### BASE METAL FLOTATION

Sequential sulphide rougher and cleaner flotation tests were performed under is the following conditions:
Ore was dry jaw and rolls crushed to 100% passing 1.70 mm.
Grind at 66% solids in an open mild steel ball mill and charge to target P80.
Flotation rougher performed in a 3.5 L Agitair style laboratory cell.
Copper rougher concentrates generated for preparation and analysis
Air rate and time were recorded for each concentrate.

Conditions were designed to mimic the individual ore processing route including flotation feed size distribution, pH modifier and pulp Ph in grind and flotation, other reagents and modifiers, flotation time and concentrate mass pull. In all cases standard results closely match plant performance criteria.

### 4. TESTS PERFORMED

Table 1 summarises feed sources, test type and basic conditions for the tests performed. Full details of each test program results are appended.

TABLE 1
TEST SUMMARY

| TEST NO | ORE | FEED p80 | TEST NOS |
|---|---|---|---|
| A14971 | Ore 1 | 38 | JA1026-1036 |
| T0774 | Ore 2 | 130 | T01-T33 |
| T0784 | Ore 3 | 106 | T01-T13 |
| T0815 | Ore 3 | 106 | T01-T18 |

### 5. RESULTS

### Collector Flotation Assessment

The following table summarises the results for selected collector types compared with the standard collector (in bold) for each ore source.

Each of the experimental collector types presented in Table 4 either match or exceed the performance of the standard collector. Results indicate that the collectors o do function as collectors under standard test conditions designed to mimic industrial flotation conditions.

TABLE 4
SUMMARY OF FLOTATION RESULTS

| Project | | | | Mass | Cu | Rec | AU | Rec |
|---|---|---|---|---|---|---|---|---|
| No | Ore | Collector | Test No | (%) | (%) | (%) | (ppm) | (%) |
| A14971 | Ore 1 | A | JA1027 | 27.2 | 11.74 | 96.3 | 3.64 | 66.7 |
| | | B | JA1028 | 26.3 | 12.16 | 95.8 | 3.73 | 64.9 |
| | | C | JA1031 | 27.0 | 12.04 | 96.1 | 3.66 | 66.4 |
| | | E | JA1035 | 27.8 | 11.88 | 97.0 | 4.22 | 72.7 |
| | | F | JA1036 | 28.2 | 11.73 | 97.3 | 3.55 | 69.2 |
| | | 3418A | JA1022 | 35.2 | 12.15 | 95.2 | 2.72 | 63.2 |
| T0774 | Ore 2 | G | T05 | 15.6 | 9.75 | 97.3 | | |
| | | G | T16 | 14.4 | 9.94 | 99.4 | | |
| | | RTD418 | T07 | 15.0 | 9.81 | 98.7 | | |
| T0784 | Ore 3 | H | T06 | 6.64 | 3.24 | 88.5 | 13.6 | 78.8 |
| | | I | T12 | 7.02 | 3.24 | 898.1 | 12.0 | 72.2 |
| | | RTD11A | T07 | 6.05 | 3.48 | 88.2 | 13.8 | 77.4 |
| T0815 | Ore 3 | J | T02 | 3.62 | 6.37 | 88.9 | 29.7 | 88.2 |
| | | RTD11A | T01 | 3.85 | 5.81 | 85.3 | 25.3 | 87.9 |

In the Tables of Results, Collector A of Table 5 is a mixture of potassium disecondary butylmonothiophosphate and a thionocarbamate.

Collector B of Table 6 is a mixture of potassium disecondary butyl monothiophosphate and a dithiophosphate and a thionocarbamate.

Collector C of Table 7 is potassium diisobutyl monothiophosphate and a thionocarbamate.

Collector D of Table 8 is potassium disecondary butyl monothiophosphate and a dithiophosphate and a thionocarbamate in which the dithiophosphate and/or thionocarbamate is different to the dithiophosphate and thionocarbamate of Collector B.

Collector E of Table 9 is potassium disecondary butyl monthiophosphate and a thionocarbamate.

Collector F of Table 10 is potassium disecondary butyl monthiophosphate and a dithiophosphate and a thionocarbamate in which the dithiophosphate and/or thionocarbamate is different to collector B or D.

Collector 3418A of Table 11 is sodium diisobutyl dithiophosphinate sold by Cytex under the name AEROPHINE®.

Collector G of Table 12 is sodium diisobutyl monothiophosphate and a thionocarbamate.

Collector RTD4180 of Table 13 is used as a STANDARD and is a mixture of sodium diisobutyl dithiophosphate and isopropyl ethyl thionocarbamate.

Collector RTD11A of Table 14 is used as a STANDARD and is isopropyl ethyl.

Collector H of Table 16 is potassium diisobutyl monothiophosphate and a thionocarbamate.

Collector I of Table 16 is potassium diisobutyl monothiophosphate and a thionocarbamate.

Collector J of Table 19 is potassium diisobutyl monothiophosphate and a thionocarbamate in which the thionocarbamate is different of the thionocarbamate of Collectors C and I.

### ADVANTAGES OF THE INVENTION

Advantages of embodiments of the invention include that collectors containing at least one reagent A and at least one reagent B are efficient and efficacious in selectively recovering greater amounts of a selected metal and/or mineral, i.e. improved yield, most notably, copper, gold, silver, lead, nickel, platinum group minerals or zinc, particularly from sulphide ores as well as producing an improved grade of selected metal or mineral.

Another advantage of embodiments of the present invention is that the combination of reagent A and reagent B has a reduced tendency to separate into different components or phases, thereby requiring less stirring or agitation and/or allowing the combination to be added to the froth flotation process as a single mixture of the components therefore providing more efficiency and requiring less equipment.

Another advantage of embodiments of the present invention is that lesser amounts of collectors in accordance with the embodiments can be used to extract selected minerals/metals so that lower dosage rates can be used when compared to the dosage amounts of conventional collectors thereby reducing the cost of recovering and/or extracting the metal or mineral.

Another advantage is that the collector of embodiments of the present invention achieve better froth quality allowing better froth mobility to transfer from the flotation cell to the launder that collects the concentrates. Better froth mobility allows for more efficient recovery to the concentrate and contributes to faster flotation kinetics.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

It will be understood to persons skilled in the art of the invention that many modifications may be made without departing from the spirit and scope of the invention.

TABLE 5
Flotation Flowsheet, Raegent Scheme & Results Text: JA1027
TEST DETAILS:

| | |
|---|---|
| PROJECT | [symbol] |
| COMPOSITE | FEED COMP |
| TEST NO | JA1027 |
| WATER TYPE | Perth Tap Water |
| [symbol] | [symbol] |
| [symbol] | [symbol] |
| [symbol] | [symbol] |

FLOWSHEET: Collector Replacement Series A

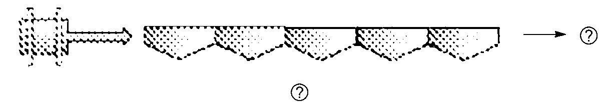

REAGENT SCHEME: CELL

| | | Cond | | | | | | | Float | [symbol] |
|---|---|---|---|---|---|---|---|---|---|---|
| | | Time | | [symbol] | [symbol] | [symbol] | [symbol] | [symbol] | Time | [symbol] |
| [symbol] | [symbol] | [symbol] | pH | [symbol] | [symbol] | [symbol] | [symbol] | [symbol] | [symbol] | [symbol] |
| Mill | | | 5.8 | 24 | 2009 | | | | | |
| Con 1 | 500 | 1 | 11.0 | 26 | 290 | 50 | 15 | 1 | 1 | 6 |
| Con 2 | 900 | 1 | 11.0 | 28 | 60 | | | | 2 | 5 |
| Con 3 | 500 | 1 | 11.0 | 52 | 50 | 25 | 16 | | 3 | 6 |
| Con 4 | 900 | 1 | 11.0 | 25 | 100 | | | | 4 | 5 |
| Con 5 | 900 | 1 | 11.0 | 56 | 50 | | 10 | | 5 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |
| Con 1 | 55.4 | 5.53 | 34.7 | 41.2 | 0.25 | 5.69 | 2.10 | 7.87 | 30.5 | 7.07 | 53.3 | 30.9 | 5.08 | 38.9 |
| Con 2 | 74.9 | 7.48 | 57.3 | 39.0 | 0.24 | 16.3 | 5.93 | 18.9 | 32.7 | 10.3 | 59.1 | 25.6 | 5.97 | 20.0 |
| Con 3 | 67.8 | 6.77 | 3.8 | 11.4 | 0.34 | 10.5 | 4.15 | 36.3 | 35.2 | 9.94 | 38.8 | 34.9 | 3.09 | 34.1 |
| Con 4 | 66.4 | 4.44 | 2.5 | 3.34 | 0.30 | 10.7 | 2.84 | 16.3 | 36.3 | 6.24 | 36.3 | 2.30 | 2.94 | 2.77 |
| Con 5 | 50.3 | 3.32 | 1.5 | 1.37 | 0.28 | 6.80 | 5.92 | 7.49 | 36.3 | 4.58 | 33.3 | 3.99 | 2.45 | 4.89 |
| [symbol] | 728.4 | 72.8 | 0.2 | 3.72 | 0.07 | 45.0 | 9.14 | 13.3 | 20.1 | 63.3 | 30.3 | 43.1 | 0.63 | 33.3 |
| Calc’d | 1001.2 | 100.0 | 3.32 | 100.0 | 0.52 | 100.0 | 0.27 | 100.0 | 23.9 | 100.0 | 16.3 | 100.0 | 1.49 | 100.0 |
| Head | | | | | | | | | | | | | | |

| | | | | | | | | | | | | | |
|---|---|---|---|---|---|---|---|---|---|---|---|---|---|
| Assay Head | | 3.48 | | 0.32 | | 0.80 | | 24.3 | | 17.1 | | | |
| Con 1 | 5.33 | 34.7 | 41.2 | 0.15 | 6.60 | 5.10 | 7.87 | 30.50 | 7.07 | 33.3 | 10.0 | 5.06 | 33.9 |
| Con 1-2 | 13.0 | 9.94 | 80.1 | 0.30 | 32.9 | 5.12 | 38.7 | 38.89 | 17.3 | 20.2 | 25.6 | 2.23 | 58.9 |
| Con 1-3 | 29.6 | 8.46 | 91.6 | 0.22 | 42.5 | 3.16 | 63.2 | 24.38 | 27.3 | 23.8 | 41.3 | 2.56 | 53.0 |
| Con 1-4 | 24.3 | 7.37 | 94.9 | 0.23 | 52.3 | 2.23 | 79.5 | 24.67 | 34.1 | 27.7 | 50.9 | 2.63 | 58.7 |
| Con 1-5 | 27.2 | 6.72 | 96.3 | 0.24 | 50.0 | 2.32 | 36.8 | 27.75 | 38.7 | 28.3 | 36.0 | 2.61 | 66.7 |

[symbol]

indicates data missing or illegible when filed

TABLE 6
Flotation Flowsheet, Raegent Scheme & Results Text: JA1028
TEST DETAILS:

| | |
|---|---|
| PROJECT | [symbol] |
| COMPOSITE | FEED COMP |
| TEST NO | JA1028 |
| WATER TYPE | Perth Tap Water |
| [symbol] | [symbol] |
| [symbol] | [symbol] |
| [symbol] | [symbol] |

FLOWSHEET: Collector Replacement Series B

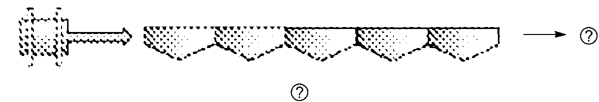

REAGENT SCHEME: CELL

| | | Cond | | | | | | | Float | [symbol] |
|---|---|---|---|---|---|---|---|---|---|---|
| | | Time | | [symbol] | [symbol] | [symbol] | [symbol] | [symbol] | Time | [symbol] |
| [symbol] | [symbol] | [symbol] | pH | [symbol] | [symbol] | [symbol] | [symbol] | [symbol] | [symbol] | [symbol] |
| Mill | | | 9.8 | 30 | 1000 | | | | | |
| Con 1 | 900 | 1 | 11.0 | 35 | 250 | 50 | 15 | | 5 | 6 |
| Con 2 | 500 | 1 | 11.0 | 25 | 80 | | | | 2 | 6 |
| Con 3 | 900 | 1 | 11.0 | 36 | 50 | 25 | 16 | | 3 | 6 |
| Con 4 | 900 | 1 | 11.0 | 36 | 100 | | | | 4 | 5 |
| Con 5 | 900 | 1 | 11.0 | 36 | 30 | | 10 | | 3 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |
| Con 1 | [symbol] | 5.34 | 34.9 | 58.4 | 0.37 | 6.20 | 1.26 | 7.32 | 30.4 | 6.33 | 33.5 | 10.2 | 4.64 | 15.5 |
| Con 2 | 66.6 | 5.58 | 33.9 | 47.2 | 0.27 | 14.0 | 2.03 | 17.7 | 32.1 | 8.92 | 34.2 | 15.5 | 4.60 | 20.3 |
| Con 3 | 69.2 | 5.98 | 3.84 | 33.7 | 0.36 | 20.3 | 4.39 | 39.9 | 24.5 | 20.2 | 36.3 | 25.0 | 3.32 | 15.5 |
| Con 4 | 433.8 | 4.29 | 2.98 | 3.23 | 0.33 | 10.7 | 2.67 | 14.8 | 36.1 | 6.47 | 35.9 | 5.14 | 2.77 | 3.97 |
| Con 5 | 53.7 | 3.87 | 3.87 | 2.36 | 0.29 | 7.40 | 1.76 | 7.27 | 36.4 | 4.82 | 33.3 | 6.36 | 2.57 | 2.60 |
| [symbol] | 736.7 | 73.7 | 0.19 | 4.28 | 9.83 | 42.5 | 0.13 | 13.5 | 20.5 | 63.1 | 20.4 | 43.3 | 9.72 | 35.1 |
| Calc’d | 999.3 | 100.0 | 3.89 | 100.0 | 0.13 | 100.0 | 0.72 | 100.0 | 23.8 | 100.0 | 19.9 | 100.0 | 2.53 | 100.0 |
| Head | | | | | | | | | | | | | | |

| | | | | | | | | | | | | | |
|---|---|---|---|---|---|---|---|---|---|---|---|---|---|
| Assay Head | | 3.48 | | 0.12 | | 0.80 | | 34.3 | | 17.2 | | | |
| Con 1 | 3.54 | 24.9 | 38.4 | 0.32 | 6.20 | 1.20 | 7.97 | 39.40 | 6.33 | 33.2 | 30.2 | 4.54 | 25.0 |
| Con 1-2 | 23.8 | 17.3 | 25.5 | 0.21 | 20.3 | 1.63 | 25.4 | 23.20 | 15.5 | 34.2 | 24.0 | 4.83 | 36.1 |
| Con 1-3 | 28.2 | 25.6 | 99.2 | 0.27 | 40.4 | 1.67 | 23.3 | 32.13 | 25.6 | 37.0 | 39.0 | 4.33 | 53.4 |
| Con 1-4 | 23.3 | 23.6 | 34.0 | 0.25 | 53.1 | 2.87 | 89.5 | 55.19 | 32.9 | 35.2 | 48.2 | 5.88 | 39.3 |
| Con 1-5 | 26.3 | 52.3 | 95.5 | 0.28 | 58.5 | 2.56 | 87.3 | 33.52 | 36.9 | 35.0 | 54.5 | 3.33 | 69.9 |

[symbol]

indicates data missing or illegible when filed

TABLE 7
Flotation Flowsheet, Reagant Scheme & Results Test: JA1031
TEST DETAILS:

| | |
|---|---|
| PROJECT | [symbol] |
| COMPOSITE | FEED COMP |
| TEST NO | JA1031 |
| WATER TYPE | Perth Tap Water |
| [symbol] | [symbol] |
| [symbol] | [symbol] |
| [symbol] | [symbol] |

FLOWSHEET: Collector Replacement Series C

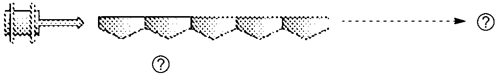

REAGENT SCHEME: CELL

[symbol]

| | | Cond | | | | | | | Float | |
|---|---|---|---|---|---|---|---|---|---|---|
| | | Time | | | | | | | Time | |
| [symbol] | [symbol] | [symbol] | pH | [symbol] | [symbol] | [symbol] | [symbol] | [symbol] | [symbol] | [symbol] |
| Mill | | | 2.3 | 77 | 1000 | | | | | |
| Con 1 | 500 | 1 | 11.0 | 18 | 340 | 50 | [symbol] | 1 | 1 | 6 |
| Con 2 | 900 | 1 | 11.0 | 16 | 416 | | | | 2 | 5 |
| Con 3 | 500 | 1 | 11.0 | 27 | 90 | 25 | [symbol] | | 3 | 6 |
| Con 4 | 900 | 1 | 11.0 | 30 | 180 | | | | 4 | 5 |
| Con 5 | 900 | 2 | 11.0 | 28 | 119 | | [symbol] | | 5 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |

| | | | | | | | | | | | | | | |
|---|---|---|---|---|---|---|---|---|---|---|---|---|---|---|
| Con 1 | 54.5 | 6.44 | 24.4 | 46.4 | 0.29 | 8.42 | 1.53 | 15.5 | 10.3 | 8.32 | 33.2 | 22.7 | 4.74 | 29.4 |
| Con 2 | 77.4 | 7.73 | 15.5 | 33.4 | 0.33 | 12.0 | 3.45 | 34.0 | 32.2 | 10.4 | 35.2 | 35.3 | 3.36 | 28.3 |
| Con 3 | 62.5 | 4.24 | 3.34 | 10.3 | 0.36 | 13.3 | 3.89 | 35.1 | 33.7 | 8.27 | 37.3 | 23.7 | 3.39 | 33.7 |
| Con 4 | 33.8 | 3.38 | 2.59 | 2.59 | 0.22 | 7.36 | 1.53 | 6.62 | 37.6 | 5.36 | 34.5 | 2.28 | 2.28 | 6.47 |
| Con 5 | 32.8 | 3.24 | 1.08 | 1.95 | 0.28 | 7.00 | 1.59 | 4.53 | 36.5 | 4.97 | 33.8 | 8.56 | 2.54 | 5.31 |
| [symbol] | 731.0 | 73.0 | 9.18 | 3.58 | 0.07 | 35.3 | 0.11 | 15.2 | 20.4 | 62.6 | 30.3 | 43.7 | 5.73 | 33.6 |
| Calc'd | 1001.5 | 100.0 | 3.38 | 100.0 | 0.15 | 100.0 | 2.32 | 100.0 | 1.40 | 100.0 | 163 | 100.0 | 1.59 | 100.0 |
| Head | | | | | | | | | | | | | | |

| | | | | | | | | | | | | | |
|---|---|---|---|---|---|---|---|---|---|---|---|---|---|
| Assay Head | | 1.42 | | 0.13 | | 0.30 | | 24.3 | | 37.2 | | | |
| Con 1 | 6.44 | 24.4 | 46.6 | 0.39 | 3.43 | 1.63 | 13.5 | 36.36 | 8.23 | 33.2 | 12.7 | 4.74 | 20.4 |
| Con 1-2 | 12.2 | 24.4 | 81.7 | 0.18 | 28.1 | 2.27 | 47.4 | 17.56 | 12.5 | 29.2 | 25.8 | 1.94 | 22.7 |
| Con 1-3 | 33.2 | 2.45 | 91.9 | 0.24 | 40.4 | 2.48 | 78.9 | 23.11 | 27.8 | 24.4 | 32.5 | 2.53 | 52.4 |
| Con 1-4 | 25.8 | 8.25 | 94.5 | 0.34 | 55.7 | 2.35 | 82.2 | 25.37 | 28.1 | 25.3 | 48.8 | 2.42 | 58.6 |
| Con 1-5 | 27.0 | 8.23 | 96.1 | 0.25 | 58.7 | 2.20 | 89.7 | 36.57 | 32.8 | [symbol] | 55.3 | 2.44 | 64.4 |

[symbol]

indicates data missing or illegible when filed

TABLE 8
Flotation Flowsheet, Reagant Scheme & Results Test: JA2032
TEST DETAILS:

| | |
|---|---|
| PROJECT | [symbol] |
| COMPOSITE | FEED COMP |
| TEST NO | [symbol] |
| WATER TYPE | Perth Tap Water |
| [symbol] | [symbol] |
| [symbol] | [symbol] |
| [symbol] | [symbol] |

FLOWSHEET: Collector Replacement Series D

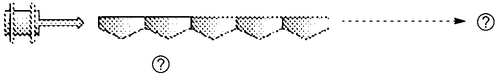

REAGENT SCHEME: CELL

[symbol]

[symbol]

| | | Cond | | | | | | | Float | |
|---|---|---|---|---|---|---|---|---|---|---|
| | | Time | | | | | | | Time | |
| [symbol] | [symbol] | [symbol] | pH | [symbol] | [symbol] | [symbol] | [symbol] | [symbol] | [symbol] | [symbol] |
| Mill | | | 9.3 | 55 | 1000 | | | | | |
| Con 1 | 500 | 1 | 11.0 | 12 | 436 | 50 | [symbol] | 1 | 3 | 6 |
| Con 2 | 900 | 1 | 11.0 | 14 | 20 | | | | 2 | 5 |
| Con 3 | 500 | 1 | 11.0 | 27 | 100 | 25 | 15 | | 3 | 6 |
| Con 4 | 900 | 1 | 11.0 | 28 | 36 | | | | 4 | 5 |
| Con 5 | 900 | 2 | 11.0 | 200 | 200 | | 20 | | 5 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |
| Con 1 | 33.4 | 3.13 | 24.4 | 33.4 | 0.23 | 6.51 | 2.38 | 88.5 | 39.2 | 6.48 | 33.2 | 10.1 | 4.91 | 15.6 |
| Con 2 | 72.7 | 7.16 | 18.1 | 38.7 | 0.26 | 23.7 | 2.50 | 23.8 | 33.0 | 8.36 | 34.6 | 34.7 | 4.55 | 20.6 |
| Con 3 | 68.3 | 8.32 | 7.02 | 23.8 | 0.28 | 19.9 | 4.28 | 36.7 | 34.6 | 89.43 | 38.0 | 34.2 | 3.44 | 14.2 |
| Con 4 | 50.3 | 5.03 | 3.16 | 4.63 | 0.32 | 13.6 | 2.36 | 15.3 | 35.8 | 7.73 | 36.7 | 11.0 | 3.39 | 10.5 |
| Con 5 | 30.3 | 5.02 | 1.73 | 1.55 | 0.28 | 2.47 | 2.27 | 3.06 | 36.3 | 4.66 | 32.1 | 5.13 | 2.70 | 3.16 |
| [symbol] | 732.8 | 23.1 | 0.12 | 3.83 | 0.06 | 37.2 | 0.25 | 10.5 | 20.3 | 62.1 | 10.1 | 43.9 | 6.73 | 53.7 |
| Calc’d | 1002.5 | 100.0 | 9.35 | 100.0 | 0.23 | 100.0 | 9.78 | 100.0 | 23.9 | 100.0 | 28.3 | 100.0 | 1.38 | 100.0 |
| Head | | | | | | | | | | | | | | |

| | | | | | | | | | | | | | |
|---|---|---|---|---|---|---|---|---|---|---|---|---|---|
| Assay Head | | 3.48 | | 0.53 | | 0.89 | | 34.3 | | 57.1 | | | |
| Con 1 | 3.33 | 34.4 | 37.4 | 0.35 | 6.51 | 3.33 | 5.86 | 50.20 | 8.23 | 33.2 | 16.1 | 4.74 | 15.4 |
| Con 1-2 | 12.3 | 10.5 | 76.5 | 0.53 | 22.3 | 1.48 | 32.4 | 28.84 | 12.5 | 29.2 | 24.8 | 1.94 | 22.7 |
| Con 1-3 | 18.0 | 9.34 | 89.9 | 0.22 | 42.1 | 2.43 | 39.2 | 24.37 | 27.8 | 25.5 | 32.5 | 2.95 | 52.4 |
| Con 1-4 | 23.8 | 8.03 | 94.3 | 0.24 | 55.7 | 2.41 | 84.8 | 28.83 | 28.1 | 28.1 | 48.8 | 1.91 | 68.1 |
| Con 1-5 | 26.9 | 7.32 | 96.3 | 0.28 | 62.9 | 2.12 | 29.4 | 27.85 | 32.8 | 28.8 | 55.3 | 2.97 | 66.3 |

[symbol]

indicates data missing or illegible when filed

TABLE 9
Flotation Flowsheet, Reagant Scheme & Results Test: [symbol]
TEST DETAILS:

| | |
|---|---|
| PROJECT | [symbol] |
| COMPOSITE | FEED COMP |
| TEST NO | [symbol] |
| WATER TYPE | Perth Tap Water |
| [symbol] | [symbol] |
| [symbol] | [symbol] |
| [symbol] | [symbol] |

FLOWSHEET: Collector Replacement Series E

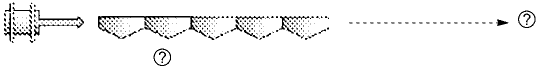

REAGENT SCHEME: CELL

[symbol]

[symbol]

| | | Cond | | | | | | | Float | |
|---|---|---|---|---|---|---|---|---|---|---|
| | | Time | | | | | | | Time | |
| [symbol] | [symbol] | [symbol] | pH | [symbol] | [symbol] | [symbol] | [symbol] | [symbol] | [symbol] | [symbol] |
| Mill | | | 3.7 | 195 | | | | | | |
| Con 1 | 500 | [symbol] | 11.0 | 20 | 276 | 50 | [symbol] | [symbol] | 1 | 6 |
| Con 2 | 900 | [symbol] | 11.0 | 28 | 39 | | | | 2 | 5 |
| Con 3 | 500 | [symbol] | 11.0 | 31 | 20 | 25 | 18 | | 3 | 6 |
| Con 4 | 900 | [symbol] | 11.0 | 33 | 30 | | | | 4 | 5 |
| Con 5 | 900 | [symbol] | 11.0 | 35 | 10 | | 16 | | 5 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |

| | | | | | | | | | | | | | | |
|---|---|---|---|---|---|---|---|---|---|---|---|---|---|---|
| Con 1 | 62.6 | 6.78 | 24.3 | 48.5 | 0.28 | 9.32 | 1.23 | 10.7 | 10.3 | 8.32 | 33.2 | 22.7 | 4.74 | 29.4 |
| Con 2 | 71.2 | 7.30 | 13.8 | 33.4 | 0.30 | 12.0 | 2.31 | 35.2 | 32.2 | 10.4 | 35.2 | 35.3 | 3.36 | 28.3 |
| Con 3 | 68.1 | 6.59 | 5.38 | 10.4 | 0.35 | 19.4 | 4.47 | 18.1 | 33.7 | 8.27 | 37.3 | 23.7 | 3.39 | 33.7 |
| Con 4 | 40.2 | 4.09 | 2.39 | 2.22 | 0.29 | 9.75 | 2.36 | 13.32 | 37.6 | 5.36 | 34.5 | 2.28 | 2.28 | 6.47 |
| Con 5 | [symbol] | 3.27 | 1.45 | 1.43 | 0.27 | 7.42 | 1.53 | 6.48 | 36.5 | 4.97 | 33.8 | 8.56 | 2.54 | 5.31 |
| [symbol] | 734.2 | 72.0 | 0.14 | 1.98 | 0.06 | 36.4 | 0.12 | 15.3 | 20.4 | 62.6 | 30.3 | 43.7 | 5.73 | 33.6 |
| Calc'd | 1002.3 | 100.0 | 3.40 | 100.0 | 0.32 | 100.0 | 0.75 | 100.0 | [symbol] | [symbol] | 163 | 100.0 | 1.59 | 100.0 |
| Head | | | | | | | | | | | | | | |

| | | | | | | | | | | | | | |
|---|---|---|---|---|---|---|---|---|---|---|---|---|---|
| Assay Head | | 3.48 | | 0.32 | | 0.84 | | 24.3 | | [symbol] | | | |
| Con 1 | 6.78 | 24.3 | 48.5 | 0.36 | 0.52 | 1.63 | 13.5 | 30.80 | 2.45 | 32.9 | 23.2 | 4.80 | 20.2 |
| Con 1-2 | 13.8 | 8.19 | 82.4 | 0.55 | 3.74 | 2.27 | 47.4 | 10.83 | 18.4 | 37.8 | 27.8 | 3.11 | 47.0 |
| Con 1-3 | 29.5 | 7.35 | 92.5 | 0.2 | 48.4 | 2.48 | 78.9 | 22.81 | 28.2 | 33.8 | 23.8 | 3.20 | 60.8 |
| Con 1-4 | 24.3 | 6.54 | 95.0 | 0.23 | 55.7 | 2.35 | 82.2 | 29.98 | 34.2 | 25.8 | 25.8 | 3.25 | 97.8 |
| Con 1-5 | 27.8 | 5.94 | 97.0 | 0.23 | [symbol] | 2.20 | 89.7 | 26.46 | 30.2 | 24.2 | 56.2 | 3.05 | 73.7 |

[symbol]

indicates data missing or illegible when filed

TABLE 10
Flotation Flowsheet, Reagant Scheme & Results Test: JA1936
TEST DETAILS:

| | |
|---|---|
| PROJECT | [symbol] |
| COMPOSITE | FEED COMP |
| TEST NO | [symbol] |
| WATER TYPE | Perth Tap Water |
| [symbol] | [symbol] |
| [symbol] | [symbol] |
| [symbol] | [symbol] |

FLOWSHEET: Collector Replacement Series F

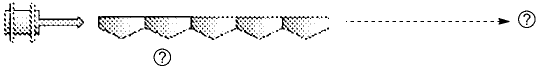

REAGENT SCHEME: CELL

[symbol]

[symbol]

| | | Cond | | | | | | | Float | |
|---|---|---|---|---|---|---|---|---|---|---|
| | | Time | | | | | | | Time | |
| [symbol] | [symbol] | [symbol] | pH | [symbol] | [symbol] | [symbol] | [symbol] | [symbol] | [symbol] | [symbol] |
| Mill | | | 9.7 | 73 | | | | | | |
| Con 1 | 500 | 2 | 11.0 | 22 | 340 | 50 | 15 | 1 | 1 | 6 |
| Con 2 | 900 | 1 | 11.0 | 25 | 140 | | | | 2 | 5 |
| Con 3 | 500 | 1 | 11.0 | 38 | 30 | 25 | 18 | | 3 | 6 |
| Con 4 | 900 | 1 | 11.0 | 31 | 40 | | | | 4 | 5 |
| Con 5 | 900 | 1 | 11.0 | 34 | 20 | | 16 | | 5 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |
| Con 1 | 52.5 | 2.89 | 24.9 | 43.7 | 0.58 | 8.78 | 1.32 | 10.7 | 30.6 | 7.52 | 33.1 | 22.7 | 3.73 | 19.4 |
| Con 2 | 81.5 | 8.22 | 16.4 | 39.0 | 0.36 | 19.9 | 2.38 | 35.2 | 32.3 | 11.0 | 32.9 | 16.8 | 2.42 | 24.3 |
| Con 3 | 64.5 | 5.23 | 9.96 | 38.2 | 0.33 | 28.4 | 4.15 | 18.1 | 35.7 | 8.50 | 36.5 | 15.9 | 3.50 | 25.6 |
| Con 4 | 42.8 | 4.26 | 2.48 | 3.66 | 0.36 | 10.3 | 1.98 | 13.32 | 37.6 | 8.58 | 36.3 | 8.63 | 2.64 | 7.65 |
| Con 5 | 39.2 | 3.63 | 1.54 | 1.30 | 0.25 | 7.45 | 1.35 | 6.48 | 36.5 | 1.34 | 32.4 | 6.74 | 2.38 | 5.77 |
| [symbol] | 717.8 | 72.0 | 0.53 | 2.74 | 0.06 | 33.2 | 3.18 | 15.3 | 23.0 | 58.8 | 9.8 | 43.8 | 0.62 | 30.8 |
| Calc'd | 1002.3 | 100.0 | 3.41 | 100.0 | 0.32 | 100.0 | 0.77 | 100.0 | 34.0 | 100.0 | 169 | 100.0 | 2.45 | 100.0 |
| Head | | | | | | | | | | | | | | |

| | | | | | | | | | | | | | |
|---|---|---|---|---|---|---|---|---|---|---|---|---|---|
| Assay Head | | 3.48 | | 0.32 | | 3.86 | | 24.3 | | 171 | | | |
| Con 1 | 5.98 | 34.9 | 23.7 | 0.28 | 27.9 | 3.32 | 10.3 | 30.56 | 7.62 | 33.1 | 23.2 | 3.73 | 25.4 |
| Con 1-2 | 34.2 | 9.44 | 82.7 | 0.37 | 28.7 | 1.80 | 38.7 | 10.83 | 12.7 | 29.1 | 28.5 | 2.54 | 40.3 |
| Con 1-3 | 20.5 | 3.36 | 92.8 | 0.23 | 47.1 | 2.30 | 74.7 | 24.12 | 28.3 | 25.3 | 42.4 | 2.84 | 15.2 |
| Con 1-4 | 24.7 | 7.89 | 95.9 | 0.24 | 57.4 | 2.32 | 87.4 | 26.41 | 34.2 | 27.1 | 35.5 | 2.81 | 63.5 |
| Con 1-5 | 28.2 | 3.28 | 97.3 | 0.34 | 54.2 | 2.18 | 90.6 | 27.56 | 40.2 | 27.8 | 28.2 | 2.76 | 69.2 |

[symbol]

indicates data missing or illegible when filed

TABLE 11
Flotation Flowsheet, Reagant Scheme & Results Test: JA2032
TEST DETAILS:

| | |
|---|---|
| PROJECT | [symbol] |
| COMPOSITE | DEGRUSSA COMPOSITE |
| TEST NO | IA1022 |
| WATER TYPE | Perth Tap Water |
| [symbol] | [symbol] |
| [symbol] | [symbol] |
| [symbol] | [symbol] |

FLOWSHEET: Collector Replacement Series [symbol] STANDARD

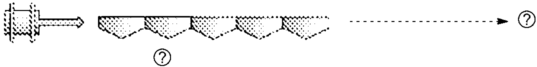

REAGENT SCHEME: CELL

[symbol]

[symbol]

| | | Cond | | | | | | | Float | |
|---|---|---|---|---|---|---|---|---|---|---|
| | | Time | | | | | | | Time | |
| [symbol] | [symbol] | [symbol] | pH | [symbol] | [symbol] | [symbol] | [symbol] | [symbol] | [symbol] | [symbol] |
| Mill | | | 8.2 | 24 | 1000 | | | | | |
| Con 1 | 500 | 1 | 11.0 | −55 | 700 | 50 | 13 | 2 | 1 | 6 |
| Con 2 | 900 | 1 | 11.0 | −17 | 90 | | | | 2 | 5 |
| Con 3 | 500 | 1 | 11.0 | −23 | 120 | 25 | 16 | | 3 | 6 |
| Con 4 | 900 | 1 | 11.0 | −12 | 80 | | | | 4 | 5 |
| Con 5 | 900 | 2 | 11.0 | −16 | 50 | | 20 | | 5 | 6 |

RESULTS:

| PRO- | WEIGHT | | COPPER | | LEAD | | ZINC | | IRON | | SILVER | | GOLD | |
|---|---|---|---|---|---|---|---|---|---|---|---|---|---|---|
| DUCT | [symbol] | [symbol] | [symbol] | [symbol] | [symbol] | [symbol] | [symbol] | [symbol] | [symbol] | [symbol] | [symbol] | [symbol] | [symbol] | [symbol] |

| | | | | | | | | | | | | | | |
|---|---|---|---|---|---|---|---|---|---|---|---|---|---|---|
| Con 1 | 20.8 | 3.05 | 23.4 | 42.0 | 0.65 | 9.59 | 0.83 | 9.55 | 10.3 | 9.57 | 33.2 | 23.6 | 2.40 | 12.8 |
| Con 2 | 78.6 | 7.86 | 17.7 | 35.0 | 2.11 | 10.2 | 1.11 | 12.8 | 32.2 | 9.80 | 34.3 | 53.5 | 3.82 | 13.5 |
| Con 3 | 87.4 | 3.74 | 7.75 | 25.2 | 0.26 | 18.8 | 3.24 | 42.7 | 33.7 | 13.3 | 30.1 | 26.7 | 3.02 | 17.4 |
| Con 4 | 54.3 | 5.05 | 4.62 | 4.52 | 0.10 | 9.53 | 1.78 | 13.2 | 37.6 | 72.8 | 35.8 | 9.00 | 3.02 | 19.00 |
| Con 5 | 54.7 | 3.27 | 3.28 | 2.36 | 0.24 | 5.96 | 1.25 | 10.2 | 36.5 | 8.38 | 36.0 | 10.0 | 2.61 | 30.8 |
| [symbol] | 648.2 | 54.8 | 2.33 | 4.77 | 0.09 | 45.0 | 0.39 | 12.4 | 20.4 | 52.8 | 71.4 | 37.1 | 0.25 | 33.6 |
| Calc'd | 959.5 | 100.0 | 4.49 | 100.0 | 0.02 | 100.0 | 0.58 | 100.0 | 1.40 | 100.0 | 19.9 | 100.0 | 2.51 | 100.0 |
| Head | | | | | | | | | | | | | | |

| | | | | | | | | | | | | | |
|---|---|---|---|---|---|---|---|---|---|---|---|---|---|
| Assay Head | | 4.82 | | 0.09 | | 0.71 | | 24.3 | | 30.3 | | | |
| Con 1 | 3.05 | 23.4 | 42.8 | 0.05 | 2.59 | 0.83 | 0.85 | 31.50 | 0.37 | 33.0 | 13.6 | 2.40 | 12.8 |
| Con 1-2 | 15.9 | 8.74 | 75.2 | 2.25 | 15.5 | 9.53 | 22.7 | 18.34 | 19.4 | 26.3 | 22.1 | 2.29 | 28.3 |
| Con 1-3 | 24.7 | 8.39 | 92.2 | 0.65 | 35.4 | 1.50 | [symbol] | 73.79 | 22.8 | 34.4 | 43.8 | 1.99 | 43.8 |
| Con 1-4 | 38.7 | 7.65 | 92.7 | 0.38 | 44.9 | 1.55 | 77.5 | 28.39 | 38.9 | 26.4 | 52.9 | 2.09 | 33.8 |
| Con 1-5 | 35.2 | 8.79 | 95.2 | 0.24 | 54.8 | 1.50 | 27.8 | 28.43 | 47.2 | 28.9 | 82.3 | 2.13 | 63.2 |

[symbol]

indicates data missing or illegible when filed

TABLE 12
ROUGHER/CLEANER FLOTATION REPORT SHEET

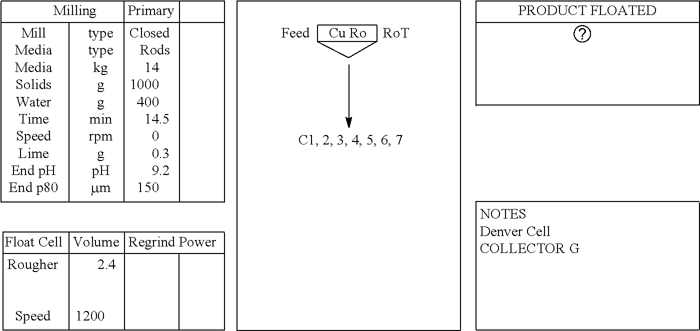

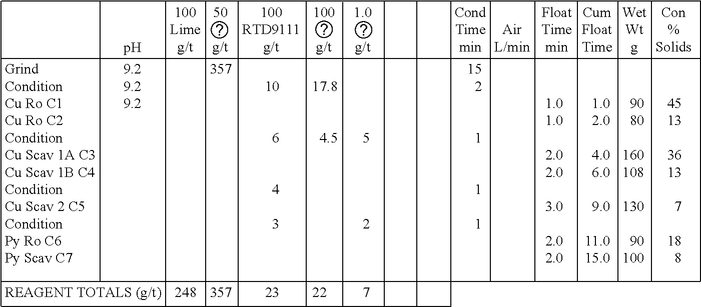

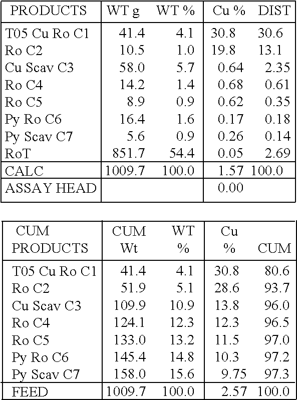

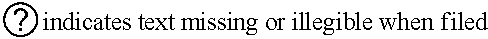

TABLE 13
ROUGHER/CLEANER FLOTATION REPORT SHEET

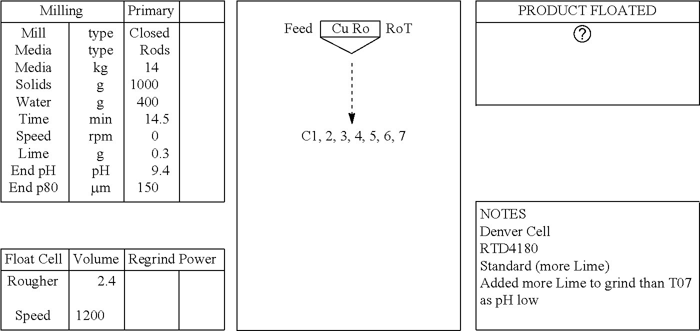

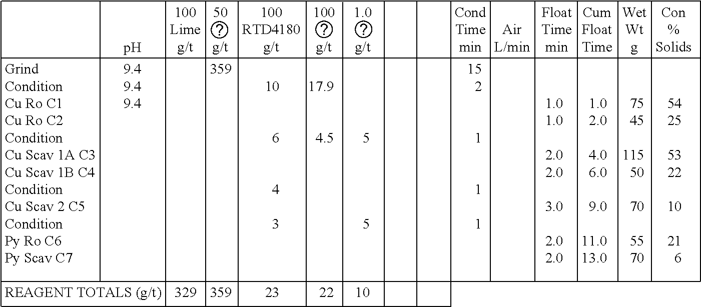

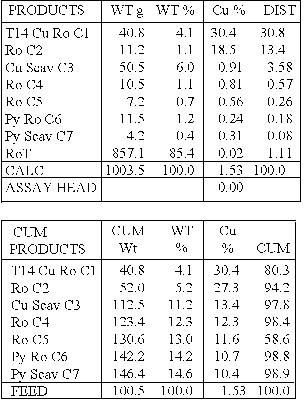

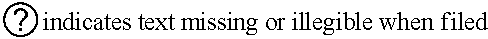

TABLE 14
ROUGHER/CLEANER FLOTATION REPORT SHEET

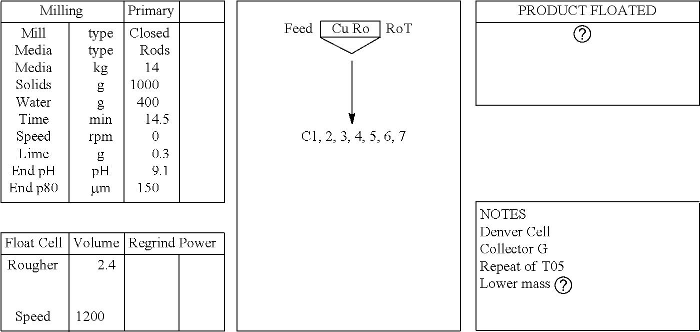

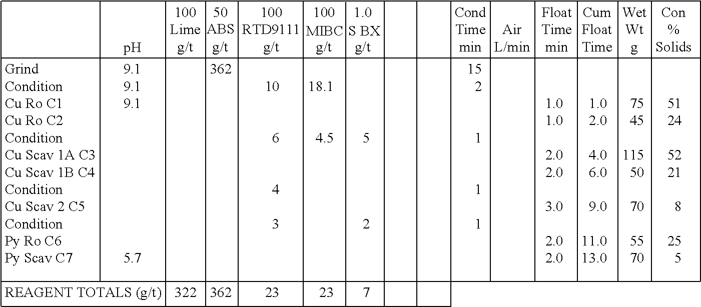

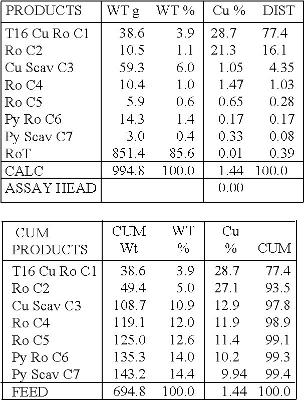

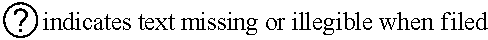

TABLE 15
BURNIE LABORATOARY: ROUGHER FLOTATION REPORT SHEET

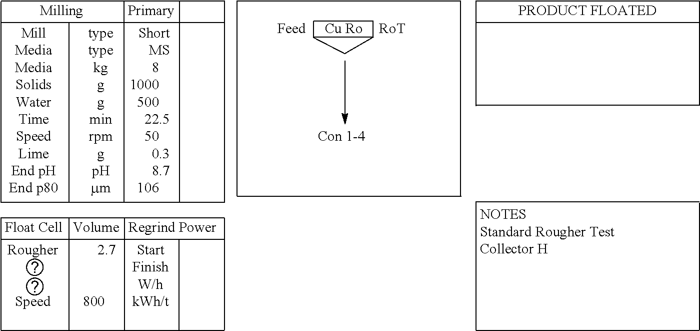

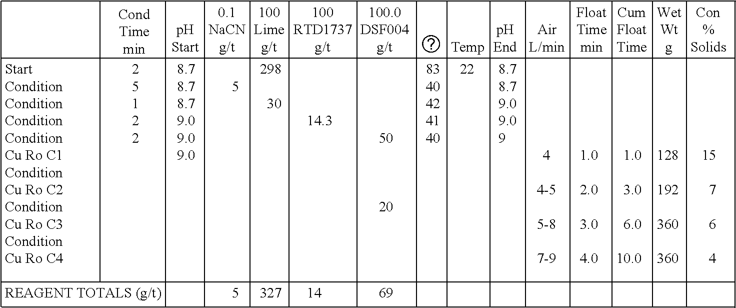

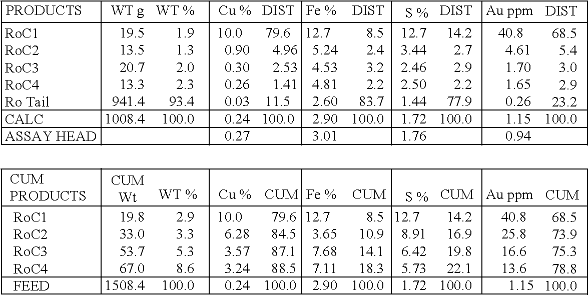

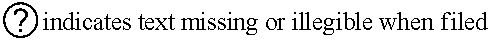

TABLE 16
BURNIE LABORATOARY: ROUGHER FLOTATION REPORT SHEET

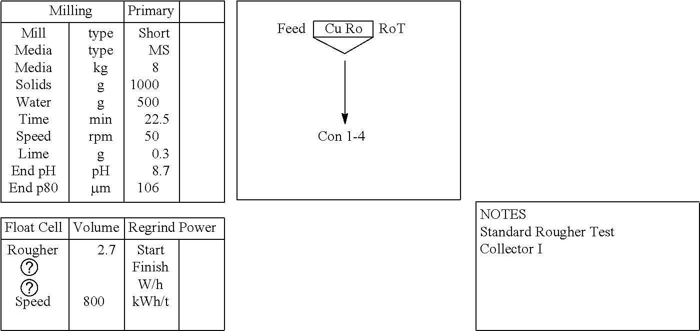

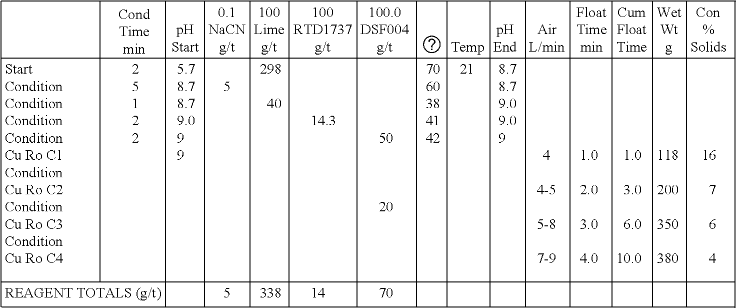

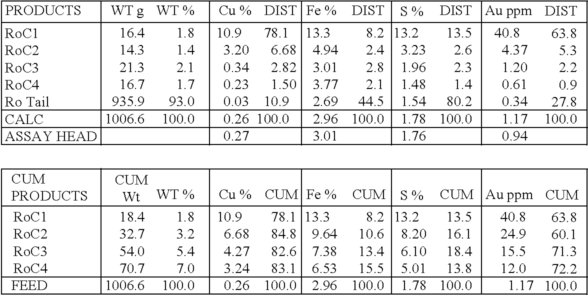

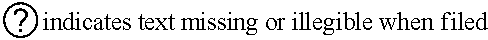

TABLE 17
BURNIE LABORATOARY: ROUGHER FLOTATION REPORT SHEET

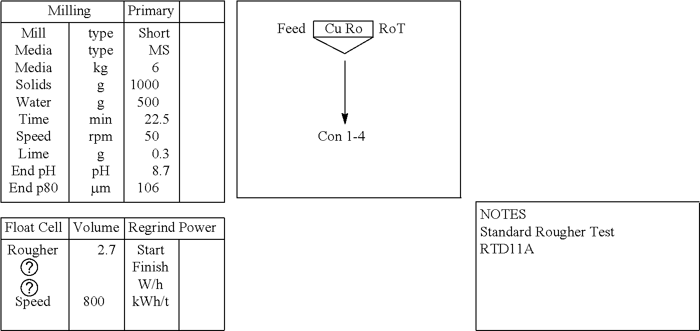

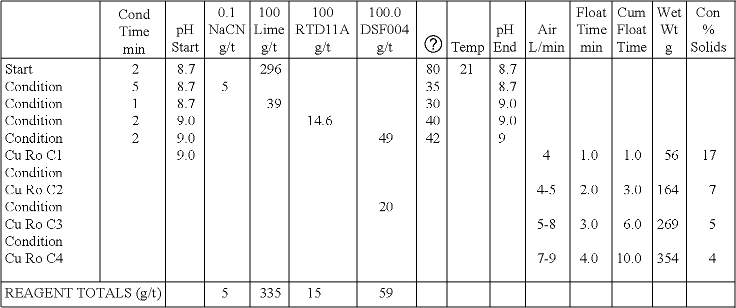

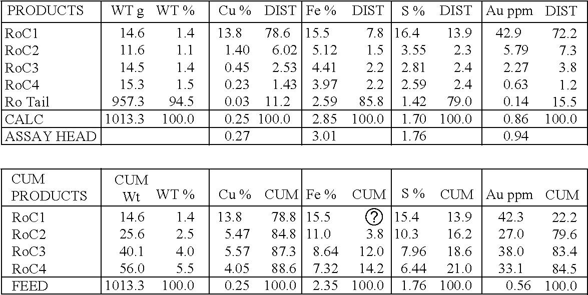

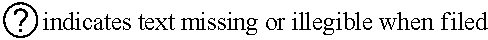

TABLE 18
BURNIE LABORATOARY: ROUGHER FLOTATION REPORT SHEET

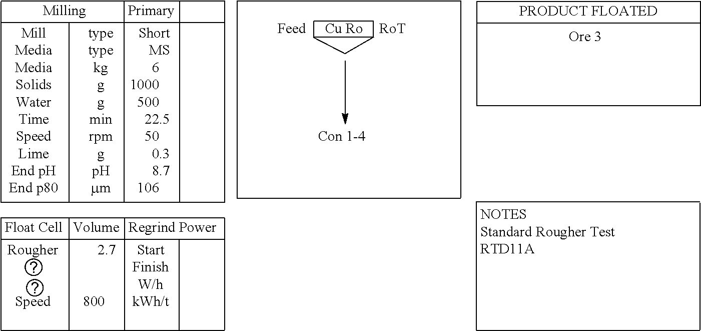

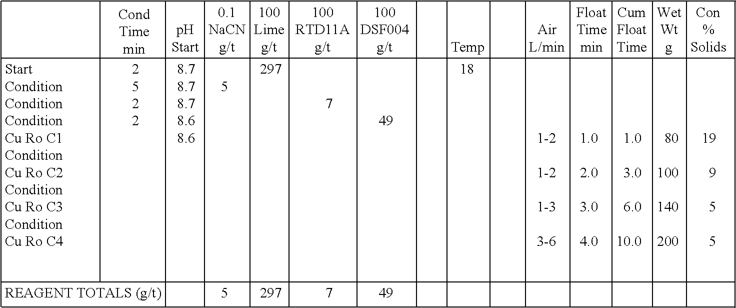

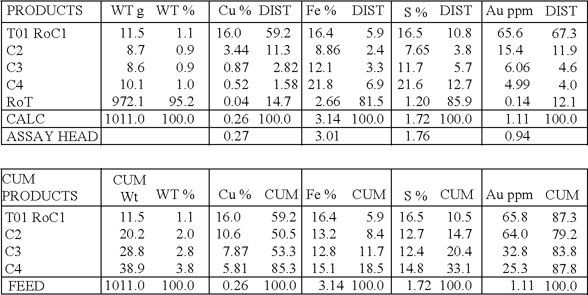

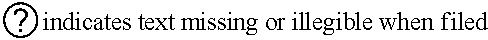

TABLE 19
BURNIE LABORATOARY: ROUGHER FLOTATION REPORT SHEET

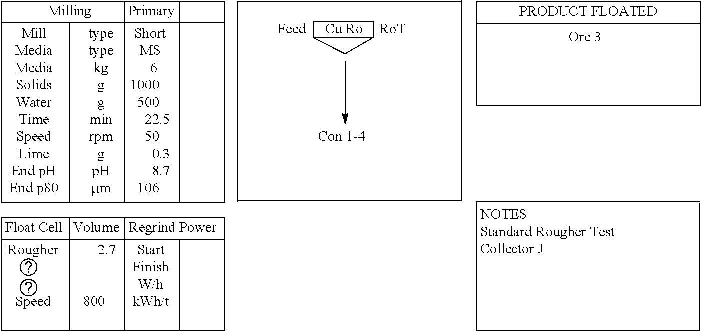

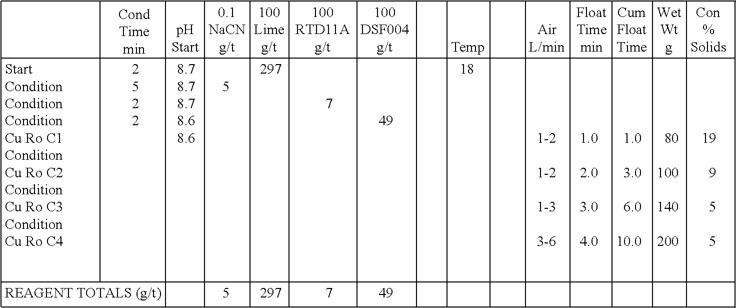

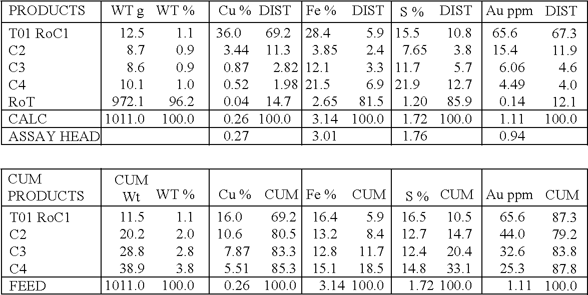

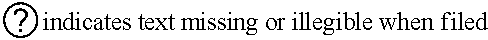

TABLE 20
BURNIE LABORATOARY: ROUGHER FLOTATION REPORT SHEET

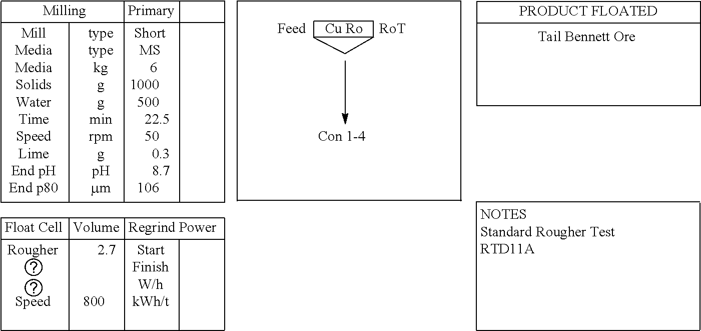

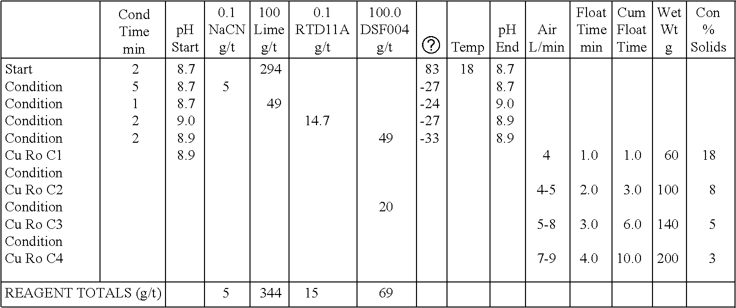

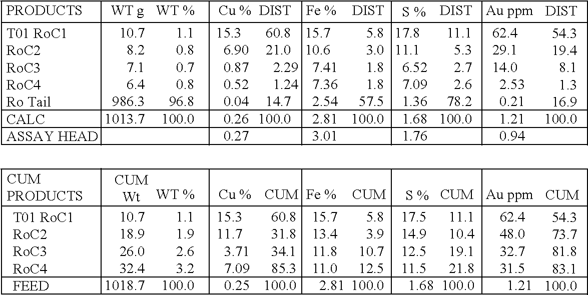

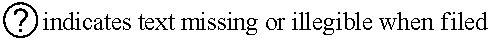

TABLE 21
BURNIE LABORATOARY: ROUGHER FLOTATION REPORT SHEET

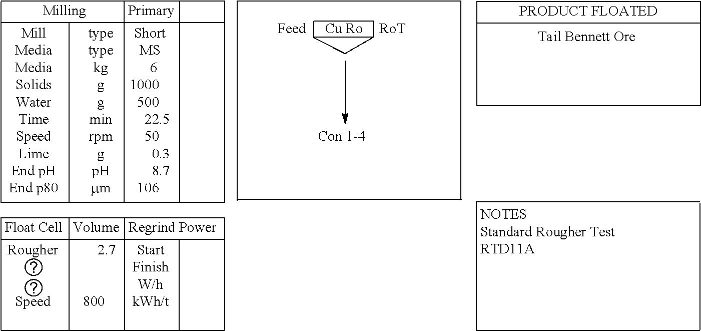

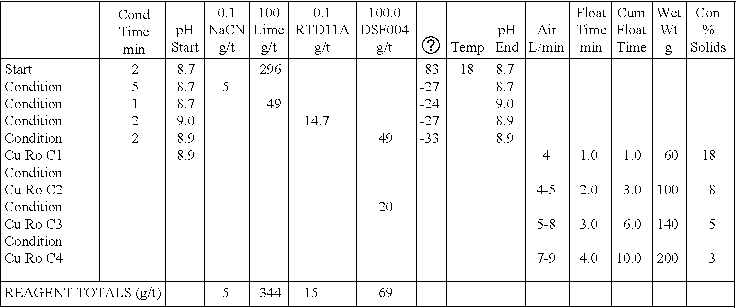

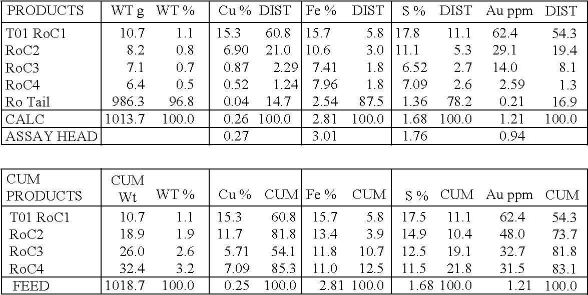

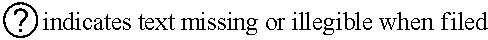

1. A collector configured to recover and/or concentrate a metal or mineral value of economic worth from a raw material containing the metal and/or mineral of economic worth in a froth flotation process, wherein the collector comprises at least one or more reagents selected from the group consisting of
(A) a thionocarbamate having the general formula (I) 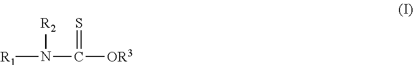
in which R₁, R₂ and R³ are the same or different and are selected from the group consisting of hydrogen, alkyl groups, allyl groups, alkenyl groups, aryl groups and alkaryl groups having from 1 to 20 carbon atoms including linear or branched carbon chains and substituted or un-substituted carbon atoms including being substituted with a hetero atom, and
(B) a monothiophosphate having the general formula
(R₄O)₂PS(OR₅) (II)
in which R₄ and R₅ are the same or different and is selected from the group consisting of hydrogen, oxygen, alkyl groups, allyl groups, alkenyl groups, aryl groups and alkaryl groups having from 1 to 20 carbon atoms, including branched or un-branched carbon chains and un-substituted or substituted carbon atoms including hetero atoms.

2. A method of recovering at least one selected metal and/or mineral from a raw material in a froth flotation process using a collector according to claim 1 comprising the steps of:
introducing the collector to the raw material, and
subjecting the raw material to a froth floatation process wherein the collector is configured to conctrate metal values and/or minerals from ores, mineral pulps, and/or slags or other raw materials containing metal and/or mineral in froth flotation processes, said collector comprising at least one or more reagents selected from the group consisting of:
(A) a thionocarbamate having the general formula (I) 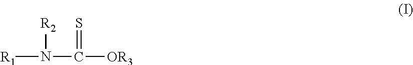
in which R₁, R₂ and R₃ are the same or different and are selected from the group consisting of hydrogen, alkyl groups, allyl groups, alkenyl groups, aryl groups and alkaryl groups having from 1 to 20 carbon atoms including linear or branched carbon chains and substituted or un-substituted carbon atoms including being substituted with a hetero atom, and
(B) a monothiophosphate having the general formula (II)
(R₄O)₂PS(OR₅) (II)
in which R₄ and R₅ are the same or different and is selected from the group consisting of hydrogen, oxygen, alkyl groups, alkenyl groups, aryl groups and alkaryl groups having from 1 to 20 carbon atoms, including branched or un-branched carbon chains and un-substituted or substituted carbon atoms including hetero atoms.

3. A collector according to claim 1, wherein the collector comprises one or more reagents of a dithiophosphate having the general formula (III) 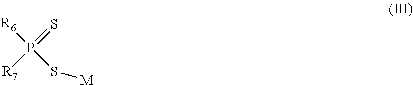
in which R₆ and R7 are the same or different and is selected from the group consisting of hydrogen, alkyl groups, alkenyl groups, aryl groups and alkaryl groups having from 1 to 20 carbon atoms, including branched or un-branched carbon chains and un-substituted or substituted carbon atoms including hetero atoms, and M is an alkali metal selected from Group I of the Periodic Table or is an ammonium ion, including substituted ammonium ions or a cresyl, a substituted cresyl or a cresyl-containing group.

4. A collector according to any claim 1 in which the collector further comprises one or more of mercaptobenzothiazole of the general formula (IV) 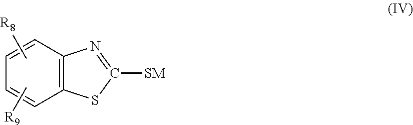
in which R₈ and R₉ may be the same or different and are selected from the croup consisting of hydrogen, alkyl groups, alkenyl groups, aryl groups and alkaryl groups having from 1 to 20 carbon atoms including branched or unbranched carbon chains and substituted or unsubstituted carbon atoms including hetero atoms, and M is hydrogen, an alkali metal selected from Group I of the periodic table, an ammonium ion, a substituted ammonium ion, a cresyl, a substituted cresyl or cresyl-containing group.

5. (canceled)

6. (canceled)

7. (canceled)

8. A collector according to claim 1 in which the collector comprises
(a) mixtures of one or more reagents selected from general formula I with one or more reagents selected from general formula II,
(b) mixtures of one or more reagents selected from general formula I and one or more reagents selected from general formula II with one or more reagents selected from Group C, wherein Group comprises:
a dithiophosphate having the general formula (III) 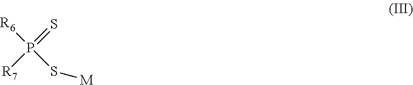
in which R₆ and R7 are the same or different and is selected from the group consisting of hydrogen, alkyl groups, alkenyl groups, aryl groups and alkaryl groups having from 1 to 20 carbon atoms, including branched or un-branched carbon chains and un-substituted or substituted carbon atoms including hetero atoms, and M is an alkali metal selected from Group I of the Periodic Table or is an ammonium ion, including substituted ammonium ions or a cresyl, a substituted cresyl or a cresyl-containing group, or
a mercaptobenzothiazole of the general formula (IV): 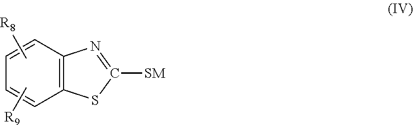
in which R₈ and R₉ may be the same or different and are selected from the group consisting of hydrogen, alkyl groups, alkenyl groups, aryl groups and alkaryl groups having from 1 to 20 carbon atoms including branched or unbranched carbon chains and substituted or unsubstituted carbon atoms including hetero atoms, and M is hydrogen, an alkali metal selected from Group I of the periodic table, an ammonium ion, a substituted ammonium ion, a cresyl, a substituted cresyl or cresyl-containing group;
(c) mixtures of one or more reagents selected from general formula I with one or more reagents selected from general formula II, with one or more reagents selected from Group D, wherein Group D is a novel or a typically, conventionally or traditionally used reagent in froth flotation separation processes, or
(d) mixtures of one or more reagents selected from general formula I with one or more reagents selected from general formula II, with one or more reagents selected from Group C and one or more reagents selected from Group D.

9. A collector according to claim 1 in which the collector is a stable mixture that does not separate on standing or when not being stirred.

10. A collector according to claim 1 in which the monothiophosphate is the mono ester or di-ester or the monothiophosphate, including the mono-ester and the di-ester of sodium diisobutyl monothiophosphate or isobutylsodium phosphorothiolate.

11. (canceled)

12. A collector according to claim 1 in which the substituents represented by any one or more of R₁ to R₉ are the same or different and are selected from the group consisting of methyl, ethyl, n-propyl, iso-propyl, n-butyl, iso-butyl, sec-butyl, tert-butyl, isoamyl, n-pentyl, iso-pentyl, neopentyl, n-hexyl, n-heptyl, n-octyl, m-cresyl, o-cresyl, p-cresyl, benzyl groups er and combinations or mixtures of isomers of two or more of the foregoing.

13. A collector according to claim 12, in which the thionocarbamate is
Alkyl Alkyl Thionocarbamates,
Isobutyl Allyl, Ethyl, Diethyl, Methyl, Dimethyl, Propyl, Propenyl, Allyl Thionocarbamate,
Isopropyl Allyl, Ethyl Diethyl, Methyl Dimethyl, Butyl Dibutyl, Propyl, Propenyl, isopropyl propyl Thionocarbamate, Amyl Methyl Thionocarbamate,
Isoamyl Ethyl thionocarbamate,
Ethyl Butyl Thionocarbamate,
Ethyl Propyl Thionocarbamate,
Methyl isobutyl Carbinol Thionocarbamate (MIBC),
Methyl isobutyl Carbinol Ethyl Thionocarbamate,
Octyl Thionocarbamate.

14. A collector according to claim 1, in which the thionocarbamate is isopropylmethylthionocarbamate, isobutylmethylthionocarbamate, isopropylethylthionocarbamate, isobutylethylthionocarbamate, isopropylpropylthionocarbamate.

15. A collector according to claim 1, wherein the monothiophosphate is in a salt form in which the salt form includes sodium, potassium, ammonium or zinc salts, including the sodium, potassium, ammonium or zinc salt of iso or di-isylbutyl monothiophosphates, secondary or di-secondary butyl monothiophosphates, iso or di-isopropyl monothiophosphates, iso or di-isopentyl monothiophosphates, cresyl or di-cresyl monothiophosphates, or dipopylcresyl monthiophosphates.

16. (canceled)

17. A collector according to claim 4, wherein the mercaptobenzothiazole is in the acid form including sodium mercaptobenzothiazole, or potassium mercaptobenzothiazole.

18. A collector according to claim 3, wherein the dithiophosphate is selected from the group consisting of:
Sodium di-isobutyl dithiophosphate,
Potassium di-isobutyl dithiophosphate,
Ammonium di-isobutyl dithiophosphate,
Sodium diethyl dithiophosphate,
Potassium diethyl dithiophosphate,
Ammonium diethyl dithiophosphate,
Sodium di-isopropyl dithiophosphate,
Potassium di-isopropyl dithiophosphate,
Ammonium di-isopropyl dithiophosphate,
Sodium di-secbutyl dithiophosphate,
Potassium di-secbutyl dithiophosphate,
Ammonium di-secbutyl dithiophosphate,
Ammonium dicresyl dithiophosphate,
Cresyl dicresyl dithiophosphate,
Sodium dialkyl dithiophosphate,
Potassium dialkyl dithiophosphate, and
Ammonium dialkyl dithiophosphate,

19. A collector according to claim 1, in which the collector comprises at least one or more of isopropylmethyl thionocarbamate and/or isopropylethyl thionocarbamate and/or isopropyl ethyl thionocarbamate and/or isopropylpropyl thionocarbamate, and a monothiophosphate selected from sodium diethyl monothiophosphate, sodium disecondarybutyl monothiophosphate, sodium di-isobutyl monothiophosphate, and sodium di-isoamyl monothiophospate.

20. A collector according to claim 1, in which the collector includes as the monothiophosphate, any one or more of the following: potassium disecondarybutyl monothiophosphate, potassium di-isobutyl monothiophosphate, sodium di-butyl monothiophosphate.

21. A collector according to claim 1, in which the collector is potassium disecondary butyl monothiophosphate with a first thionocarbamate, potassium disecondary butyl monothiophosphate with a first dithiophosphate and a thionocarbamate, potassium diisobutyl monothiophosphate with a thionocarbamate, potassium disecondary butyl monothiophosphate with a second thionocarbamate, the second dithionocarbamate being a different thionocarbamate to the first thionocarbamate, potassium disecondary butyl monothiophosphate with a second dithiophosphate and a further dithionocarbamate, sodium diisobutyl monothiophosphate with a thionocarbamate, potassium diisobutyl monothiophotphase with another thionocarbamate, potassium diisobutyl monothiophosphate with a still further thionocarbamate.

22. A collector according to claim 1, in which the amount of general formula I and general formula II is in the range from 5 to 95%, the amount of general formula I or general formula II is in the range from 10 to 90%, the amount of general formula I or general formula II is in the range from 20 to 80%, the amount of general formula I or general formula II is in the range from 30 to 70%, the amount of general formula I or general formula II is in the range from 40 to 60%, or the amount of general formula I or general formula II is about 50% each.

23. A collector according to claim 1, in which the collector further includes as reagent D any one or more of diothiophosphates, xanthates, dithiocarbamates, xanthate esters including xanthogen formates, dithiocarbamates, dithiophosphates, analino dithiophosphoric acid, analino dithiophosphates, dithiophosphonates, octyl sulphides, alcohols, hydroxemic acids, salts, esters or similar including combinations of two or more of the foregoing.

24. (canceled)

25. (canceled)

26. A collector according to claim 1, wherein the amount of collector added to the raw material is in an amount of up to 200 g/t of the raw material being treated.

27. A collector according to claim 1, in which the metal value or mineral being recovered by the use of the collector in the froth flotation process is gold, silver, zinc, lead, nickel, copper, platinum group metals, either alone or in combination.

28. (canceled)

29. (canceled)

30. A collector according to claim 1, wherein the amount of collector added to the raw material is in an amount from about 2 g/t to about 150 g/t.

31. A collector according to claim 1, wherein the amount of collector added to the raw material is in an amount from about 3 g/t to about 100 g/t.

32. A collector according to claim 1, wherein the amount of collector added to the raw material is in an amount from about about 3.5 g/t to about 80 g/t.
